(19) United States
(12) Patent Application Publication
(10) Pub. No.: US 2003/0046287 A1
(43) Pub. Date: Mar. 6, 2003

(54) Immigration status information

(76) Inventor: Harry J. Joe, Dallas, TX (US)

Correspondence Address: JENKENS & GILCHRIST, P.C., 3200 Fountain Place, 1445 Ross Avenue, Dallas, TX, 75202-2799, US

(21) Appl. No.: 09/938,026

(22) Filed: Aug. 22, 2001

(51) Int. Cl. G06F 17/30; G06F 7/00

(52) U.S. Cl. 707/10

(57) ABSTRACT

Methods, systems, and arrangements enable a service provider to facilitate communication between and among an employer and employees thereof while providing a service thereto. For example, a service provider that is interacting with a governmental entity for immigration purposes for the benefit of actual or prospective foreign national employees on behalf of a client corporation may improve client service by enabling the employees and employer to remain abreast of immigration developments. For example, an immigration status scheme in accordance with the present invention enables an employee to log into a web site and receive immigration status information relating to the employee. Such an immigration status scheme also enables an employer to receive, search, organize, etc. immigration status information for multiple employees. The employer may have the ability to limit/restrict access to certain employees at certain stages of employment.

### BACKGROUND OF THE INVENTION

1. Technical Field of the Invention

The present invention relates in general to the field of acquiring and disbursing immigration status information, and in particular, by way of example but not limitation, to conveniently providing immigration status information to an employer at an aggregate level and/or to employees thereof at an individual level using an electronic medium.

2. Description of Related Art

When a citizen of a foreign country wishes to immigrate to another country, such as to the United States of America, certain legal requirement(s) must be satisfied. In other words, for an alien to legally live and/or work in the United States, one or more legal requirements must be met. One option for enabling an alien to legally work in the United States is for the alien to obtain one of a limited number of work visas (e.g., an H-1B visa). An alien may be granted such a work visa if, for example, the alien possesses a given level of knowledge and/or skill that is desired by the private sector, and other possible legal requirements are met. In today's economy, many aliens meet this level by possessing a technological ability (e.g., a degree and/or experience in engineering, computer science, etc.) that is in demand.

For an alien to meet the relevant legal requirements, however, the alien must navigate a byzantine set of laws and rules and effectively overcome a series of hurdles that have been established by the federal government before achieving a desired immigration status. An attorney specializing in immigration law is usually employed to ensure that the stipulated requirements are met. This adds to the cost of attaining the desired immigration status. Fortunately for many would-be immigrants, companies in the private sector that have need of technologically-skilled workers often sponsor an alien by providing the legal support needed to pursue and achieve a given immigration status that enables the alien to work for the sponsoring company. This sponsorship provides many benefits to the immigrants, including the financial support to afford an attorney to aid in the acquisition of the desired legal status.

This sponsorship also benefits the company by furthering its recruiting efforts and meeting its hiring needs. While this sponsorship benefits both the company and the alien, the sponsorship unfortunately further complicates the immigration process by adding another participant thereto. Specifically, in addition to the government, an attorney (or law firm), and the alien, a company, usually as represented by a human resources (HR) department, is added to the immigration process and the series of communications and transactions thereof. In fact, an HR department often orchestrates the immigration application process by coordinating the communications between the selected law firm and the alien. Once the initial information has been acquired by the law firm from the alien, the law firm prepares the appropriate paperwork and submits it to the appropriate governmental entity(ies). Everyone, from the law firm and the HR department to the alien, must then await a response from the governmental entity(ies). In the interim, the alien is understandably constantly curious as to the status of his or her application.

Consequently, the alien typically makes repeated inquiries to the HR department as to the status of his or her immigration application during the long waiting period. In response to these repeated inquiries, the HR department may either rebuff the employee or forward the inquiry to the law firm, which adds cost and complexity to the immigration process, especially from the perspective of the sponsoring company. Furthermore, the HR department and the law firm may be simultaneously working and/or awaiting results on hundreds or even potentially thousands of such immigration applications. The burden on the HR department and the law firm can be significant merely for handling the status inquiries from the aliens that have already submitted immigration applications. This can additionally hinder their ability to address new immigration applications.

Hence, there is no convenient manner for providing information to aliens regarding the status of their immigration applications, much less for providing responses to status inquiries specifically initiated by the aliens.

Moreover, the HR department does not have convenient access for its purposes to the status of all of the immigration applications for aliens employed by the company. Likewise, there is no convenient manner for organizing or presenting the status of all, or even a portion, of the immigration applications for aliens employed by the company.

### BRIEF SUMMARY OF INVENTION

The deficiencies of the prior art are overcome by the methods, systems, and arrangements of the present invention. For example, as heretofore unrecognized, it would be beneficial to alleviate some of the internal corporate communications between foreign nationals and the HR department and/or to facilitate review of the status of all or a portion of all of the immigration applications or other immigration statuses of the foreign nationals employed by the corporation. In fact, it would be beneficial if the internal corporate communications were reduced by providing immigration status information to the foreign nationals directly and/or if the review of immigration status information of all or a portion of all of the relevant foreign nationals were facilitated using an electronic medium and interface.

In certain embodiment(s), methods, systems, and arrangements enable a service provider to facilitate communication between and among an employer and employees thereof while providing a service thereto. For example, a service provider that is interacting with a governmental entity for immigration purposes (e.g., to secure a desired immigration visa) for the benefit of actual or prospective foreign national employees on behalf of a client corporation may improve client service by enabling the employees and employer to remain abreast of immigration developments. For example, an immigration status scheme in accordance with the present invention enables an employee to log into a, e.g., web site and receive immigration status information relating to the employee. The immigration status information may include, for example, dates of expiration, applications pending, etc. Such an immigration status scheme may also enable an employer to receive, search, organize, manipulate, etc. immigration status information for multiple employees. The employer may review a listing of employees with only general information or may view each employee's entry in detail. The employer may have the ability to limit/restrict access to certain employees at certain stages of employment.

The above-described and other features of the present invention are explained in detail hereinafter with reference to the illustrative examples shown in the accompanying drawings. Those skilled in the art will appreciate that the described embodiments are provided for purposes of illustration and understanding and that numerous equivalent embodiments are contemplated herein.

### BRIEF DESCRIPTION OF THE DRAWINGS

A more complete understanding of the methods, systems, and arrangements of the present invention may be had by reference to the following detailed description when taken in conjunction with the accompanying drawings wherein:

FIG. 1 illustrates an exemplary block diagram of an exemplary environment in accordance with the present invention;

FIG. 2 illustrates an exemplary block diagram of another exemplary environment in accordance with the present invention;

FIG. 3 illustrates an exemplary method in flowchart form for providing immigration status information in accordance with the present invention;

FIG. 4 illustrates an exemplary realization of a provisioning of immigration status information in accordance with the present invention;

FIG. 5 illustrates an exemplary immigration status information database in accordance with the present invention;

FIGS. 6A, 6B, and 6C illustrate exemplary terminal screen views for providing immigration status information in accordance with the present invention;

FIGS. 7, 7A, and 7B illustrate an exemplary client profile screen in accordance with the present invention;

FIGS. 8, 8A, and 8B illustrate an exemplary project profile screen in accordance with the present invention;

FIG. 9 illustrates an exemplary starting web page for providing immigration status information in accordance with the present invention;

FIG. 10 illustrates a method in flowchart form for providing immigration status information to an employee in accordance with the present invention;

FIGS. 11A and 11B illustrate exemplary web pages for alien user registration and alien login, respectively, in accordance with the present invention;

FIG. 12 illustrates an exemplary web page for providing immigration status information to an alien in accordance with the present invention;

FIG. 13 illustrates a method in flowchart form for providing immigration status information to an employer in accordance with the present invention;

FIGS. 14A and 14B illustrate exemplary web pages for corporate user registration and corporate user registration submission acknowledgment, respectively, in accordance with the present invention;

FIG. 15 illustrates an exemplary corporate services menu web page for providing immigration status information to an employer in accordance with the present invention;

FIGS. 16A, 16B, and 16C illustrate exemplary aspects of an employee immigration status listing for providing immigration status information to an employer in accordance with the present invention;

FIGS. 17A and 17B illustrate exemplary aspects of an alien administration feature for providing immigration status information to an employer in accordance with the present invention;

FIGS. 18, 18A, and 18B illustrate exemplary aspects of a site statistics feature in conjunction with providing immigration status information to an employer in accordance with the present invention; and

FIGS. 19A-19F illustrate exemplary implementations and/or realizations of exemplary embodiment(s) of an immigration status system in accordance with the present invention.

### DETAILED DESCRIPTION OF EXEMPLARY EMBODIMENTS OF INVENTION

In the following description, for purposes of explanation and not limitation, specific details are set forth, such as particular information exchanges, screen displays, logic modules (implemented in, for example, software, hardware, firmware, some combination thereof, etc.), techniques, etc. in order to provide a thorough understanding of the present invention. However, it will be apparent to one of ordinary skill in the art that the present invention may be practiced in other embodiments that depart from these specific details. In other instances, detailed descriptions of well-known methods, devices, logical code (e.g., hardware, software, firmware, etc.), etc. are omitted so as not to obscure the description of the present invention with unnecessary detail. It should be understood that the term “module” as used herein embraces, subsumes, and includes, inter alia, object oriented programming techniques as well as so-called traditional programming techniques such as, for example, custom-developed applications.

Exemplary embodiment(s) of the present invention and its advantages are best understood by referring to FIGS. 1-19F of the drawings, like numerals being used for like and corresponding parts of the various drawings.

Referring now to FIG. 1, an exemplary block diagram of an exemplary environment in accordance with the present invention is illustrated generally at 100. The exemplary environment 100 includes a service provider 105, a related party #1 110, a related party #2 115, and a third party 120. The related party #1 110 may be related to the related party #2 115 in one or more manners. The present invention, in at least certain embodiments, may be applied to situations in which the related party #1 110 and the related party #2 115 jointly rely on the special skills, knowledge, expertise, etc. of the service provider 105 when utilizing, applying to, interacting with, etc. the third party 120. This typically necessitates significant, in terms of both duration and number of, communication exchanges between and among the various participants.

These communication exchanges can be effectuated along the communication paths 125. Specifically, a communication path 125A is illustrated between the related party #1 110 and the related party #2 115; a communication path 125B is illustrated between the related party #1 110 and the service provider 105; a communication path 125C is illustrated between the related party #2 115 and the service provider 105; and a communication path 125D is illustrated between the service provider 105 and the third party 120. In the exemplary environment 100, the service provider 105 is performing a service for the related party #1 110 and/or the related party #2 115 with respect to the third party 120. Certain embodiment(s) of the present invention advantageously reduce the number of and/or facilitate the execution of communication exchanges along, for example, the communication paths 125A, 125B, and 125C.

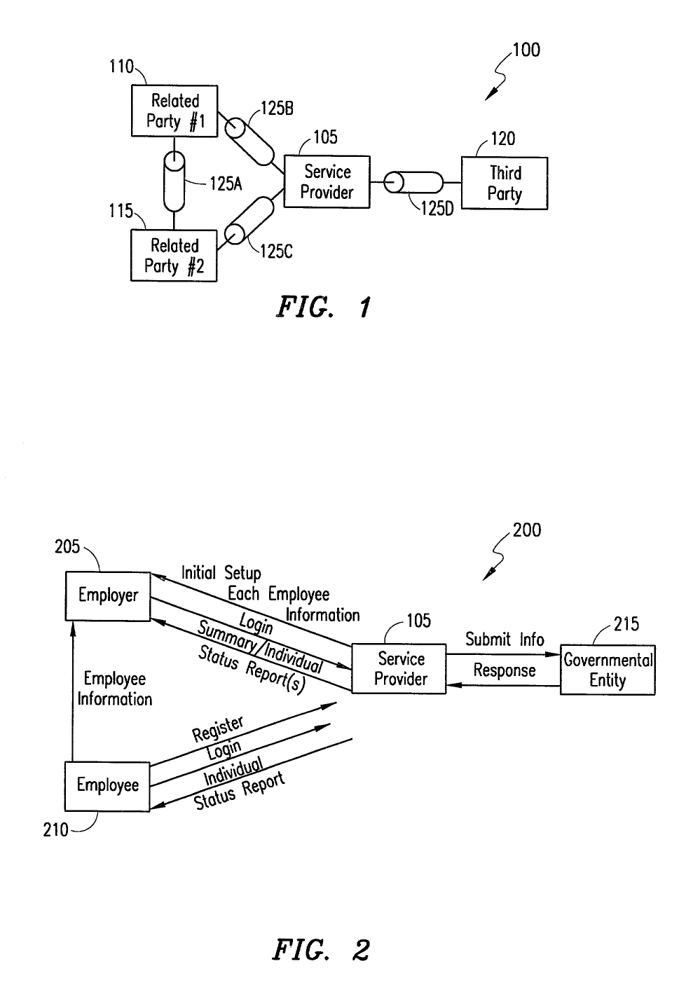

Referring now to FIG. 2, an exemplary block diagram of another exemplary environment in accordance with the present invention is illustrated generally at 200. Again, a service provider 105 is instrumental in effectuating a transaction between/among multiple parties. In the another exemplary environment 200, the service provider 105 (e.g., an attorney, a paralegal, and/or a law firm) provides a service for an employer 205 and/or an employee 210 with respect to, for example, a governmental entity 215. In providing this service, the service provider 105 communicates with the governmental entity 215, e.g., using its special skills, knowledge, expertise, etc. on behalf of the employer 205 and/or the employee 210. Application of the principles of the present invention may benefit environments pertaining to immigration and naturalization and related residency, citizenship, employment, etc. issues. It should be noted that the term “immigration” as used herein embraces, subsumes, and includes both immigration and naturalization, as well as such related issues as residency, citizenship, employment, etc.

As discussed further hereinbelow, when the employer 205 wishes to hire (or transfer into the U.S.) the employee 210, who is not a U.S. citizen, certain immigration requirements may need to be met to comport with the laws of the U.S. To meet these requirements, the employer 205 acquires employee information from the employee 210. As indicated by the standard arrow, this employee information is likely, but not necessarily, provided and received manually (e.g., regular mail, courier, etc.). It should be understood that in certain embodiment(s), this initial employee information may be acquired directly by the service provider 105. The employer 205 may initially provide each employee's setup information to the service provider 105 (e.g., if the service provider 105 does receive all such information directly from the employee 210). While a standard arrow is used to depict the providing of each employee's information to the service provider 105, it should be noted that such information may instead be provided via an electronic transmission (e.g., using an e-mail, browsing, short (e.g., text) message, etc. function/program). Once the service provider 105 has received the relevant employee information (of one or more employees), the service provider 105 performs the appropriate service(s) on behalf of the employer 205 and/or the employee 210 with respect to the governmental entity 215. This service may be performed, in part, by submitting relevant information to the governmental entity 215 and receiving response(s) at the service provider 105 from the governmental entity 215. It should be noted that the communication exchange(s) between the service provider 105 and the governmental entity 215 may alternatively be effectuated via electronic transmissions. Additional exemplary details of such (e.g., immigration related) service(s), and the submitted information as well as the received response(s), are explained hereinbelow.

The service provider 105 may collect, combine, and organize information from the various communication exchanges. For example, the service provider 105 may create a database from the employee information, the information submitted to the governmental entity 215, and the response(s) received therefrom. In certain alternative embodiment(s), as partially described above, the submitted information and the received response(s) may be exchanged electronically (e.g., by extracting relevant employee information from the database and incorporating therein the received response(s), either or both of which may be sent/received via an electronic transmission). It should be noted that the database may in fact be composed of one or more partially or fully duplicative databases or mutually exclusive databases. The database, or portion(s) thereof, may be provided to the employer 205 and/or the employee 210. The providing of the portion(s) of the database may be accomplished via electronic transmissions (e.g., using browsing software and a web server, for example, over the World Wide Web (WWW) part of the Internet).

With respect to a particular employer 205, the service provider 105 may provide access to one or more (including all) of the records related to employees 210 of the particular employer 205. The records may be presented individually, in part, or in total. The presentation of the records may be stipulated by the employer 205, as is described further hereinbelow. To gain access to the records, the employer 205 logs into the database of the service provider 105 using an electronic transmission, as indicated by the arrow with the triangular tip. Subsequently, the service provider 105 provides summary and/or individual status report(s) to the employer 205, who has the ability to customize the report(s) according to a myriad of preferences. Advantageously, the particular employer 205 is able to remain abreast of the status of the services being provided by the service provider 105 with regard to all of its employees 210.

Likewise, with respect to the employee 210, the service provider 105 may provide access to the record(s) related to the employee 210. Typically, the employee 210 only has access to his or her own record(s). To initially access the database, the employee 210 registers (e.g., using electronic transmission(s) as indicated by the triangular-tipped arrow) with the service provider 105 (e.g., optionally only after his or her employer 205 has specifically authorized the particular employee 210 to be able to have such access) After the initial registration, the employee 210 can periodically and/or spontaneously login into the database and receive an individual status report from the service provider 105. Because the service provider 105 can be frequently (e.g, nightly, in real-time, etc.) updating the record corresponding to the particular employee 210, the individual status report may contain the latest available information regarding the services being performed by the service provider 105 on behalf of the particular employee 210. Advantageously, the particular employee 210 may remain instantaneously abreast of the status of the service(s) being provided thereto by the service provider 105 without needing to inquire directly with the employer 205 and without needing to contact a live person of the service provider 105.

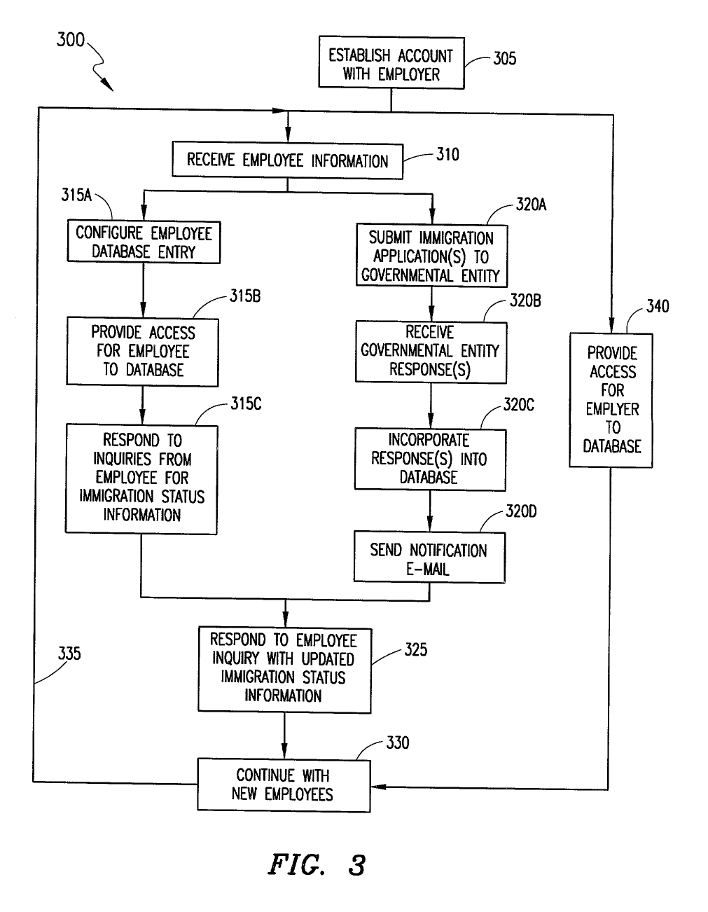

With reference now to FIG. 3, an exemplary method in flowchart form for providing immigration status information in accordance with the present invention is illustrated generally at 300. It should be noted that the flowchart 300 is, by way of example only, illustrated predominantly from the perspective of a service provider. Typically, although not necessarily, the service provider and an employer will form an agreement whereby the service provider agrees to provide a service to the employer (step 305). Thereafter, the service provider configures its database so as to be able to accept entries for employees of the employer (also step 305). Examples of a database in accordance with the present invention are described hereinbelow. The service provider receives employee information from the employer and/or an employee of the employer (step 310). Examples of employee information in accordance with the present invention are described hereinbelow.

Using the employee information, the service provider configures an employee database entry within the database (step 315A). Access to this employee database entry for the employee is provided by the service provider (e.g., after authorization, registration, etc.) (step 315B). The employee may periodically, irregularly, upon a whim, etc. inquire as to his or her immigration status (e.g., using an electronic transmission exchange via, for example, a WWW-powered, browser-enabled interface). The service provider responds to these inquiries from the employee by providing current immigration status information (step 315C). It should be understood that the steps of the flowchart 300 need not occur in any particular order. However, to improve clarity and not by way of limitation, certain steps are shown in exemplary orders and/or in exemplary parallel occurrences. For example, steps 315 are shown as possibly occurring in parallel with steps 330 and step 340.

Thus, before, during, or after the occurrence of steps 315, steps 320 may occur. To that end, and in accordance with any agreement between the service provider and the employer, for example, the service provider submits appropriate and/or requested immigration application(s) to the appropriate governmental entities (step 320A). These governmental entities may include, for example, the Immigration and Naturalization Service (under the Department of Justice), the Department of Labor, the Department of State, etc. It should be noted that the submission of application(s), in this context, may include (i) submission of standard forms, (ii) submission of specialized petitions (possibly including supporting documentation), (iii) appearance at an administrative hearing, etc. Eventually, response(s) are received from the governmental entities to which immigration application(s) were submitted (step 320B). The service provider incorporates the results from the governmental response(s) into the database at the entry of the employee (step 320C). Optionally, the service provider can send an e-mail notification to the employee (and/or the employer) to inform him or her (and/or it) of the results of the immigration applications) (step 320D), including changes to the immigration status information of the employee, including changes to immigration-related dates of the employee, etc. The e-mail may include specifics such as, for example, (i) all of the database entry of the employee, (ii) part of the database entry of the employee (e.g., only information that has changed since the last status information inquiry (e.g., of step 315C and/or step 340), (iii) a listing of affected immigration status(es), etc. Alternatively, the e-mail may only include a notification that the immigration status information in the entry of the employee has been changed/updated.

Responsive to a received e-mail notification, sua sponte on behalf of the employee, etc., the employee sends an inquiry to the service provider (e.g., using an electronic transmission exchange via, for example, a WWW-powered, browser-enabled interface). The service provider responds to the employee inquiry by providing the updated immigration status information (e.g., in a web page format, etc.) (step 325). The flowchart 300 may continue with the addition of new employees (step 330). Also, as represented by arrow 335, it should be understood that the addition of new employees to the database; the interactions represented by steps 315, 320, 340; etc. may occur continuously in parallel for multiple employees. It should also be noted that, during these parallel occurrences, the service provider may provide access to the employer to the database (step 340). This access may be realized by, for example, providing access to individual entries for individual employees, to a summary presentation of all employees of the employer, to a summary presentation of certain employees that meet one or more criteria selectable by the employer, etc. These presentation options are described in greater detail hereinbelow.

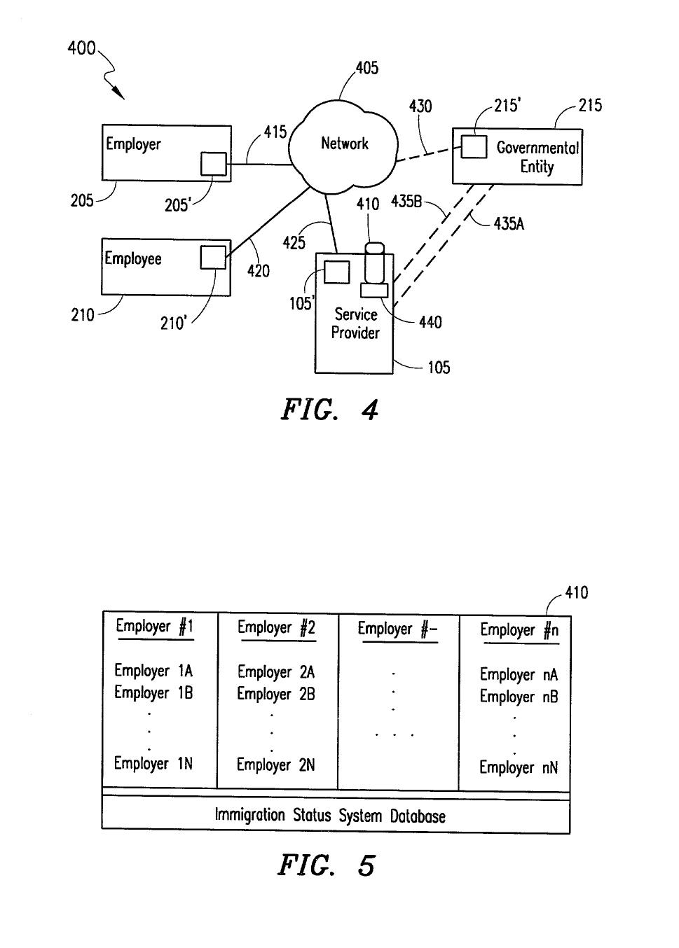

Referring now to FIG. 4, an exemplary realization of a provisioning of immigration status information in accordance with the present invention is illustrated generally at 400. An employer 205, an employee 210, a service provider 105, and a governmental entity 215 are illustrated as in communication with a network 405 (e.g., a large scale network such as the Internet, a private fiber optic network, etc.) via connection 415, connection 420, connection 425, and connection 430, respectively. These connections 415, 420, 425, and 430 may be implemented as, for example, dial-up modem connections, ISDN connections, T1 or T3 connections, asynchronous digital subscriber line (ADSL) connections, wireless connections, etc. These connections 415, 420, 425, and 430 are illustrated as being terminated at employer terminal 205′, employee terminal 210′, service provider 105′, and governmental entity 215′. It should be noted that each of terminals 205′, 210′, 105′, and 215′ may include multiple terminals and multiple points of accessibility. It should be understood that connections 415, 420, 425, and 430 may also traverse other connections and other networks (e.g., an employer terminal 205′ may be part of a local area network (LAN) that reaches the network 405 via a gateway/router and a T1 line therefrom).

The employer terminal 205′ and connection 415, the employee 210′ and connection 420, the service provider terminal 105′ and connection 425, and the governmental entity terminal 215′ and connection 430 jointly enable, via the network 405, the exchange of electronic transmission between and among the participants. It should be noted that communication between the service provider 105 and the governmental entity 215 may alternatively be effectuated (instead of via the connection 430) via a paperwork exchange 435A, verbal (e.g., in-person and face-to-face, telephonically, etc.) communication exchange 435B, etc. as indicated by the dashed lines. The service provider 105 also includes a database 410 (e.g., possibly in conjunction with a server/router/gateway/etc. 440 for formulating and/or providing information from the database 410 (e.g., in web page format)). The database 410 may store immigration status information for provisioning to the employer 205 and/or employee 210. It should be noted that the database 410, in addition to being a single database, may be composed of multiple databases that are mutually exclusive, that are partially overlapping, that are completely duplicative, etc. with respect to stored immigration status information.

Referring now to FIG. 5, an exemplary immigration status information database in accordance with the present invention is illustrated generally at 410. The exemplary immigration status system database 410 includes multiple employers #1, #2, . . . , #n. Each employer may include (or otherwise be linked to) multiple employees A, B, . . . , N. For example, employer #2 may be linked to employee 2A, employee 2B, . . . , employee 2N, etc. As illustrated, the database 410 is organized according to employer, with each employee being linked to an employer. Other alternatives, as known to those of ordinary skill in the database arts, may be utilized instead. For example, instead of, or in addition to, organizing the database 410 by employer, the database 410 may be organized according to due date(s) and/or expiration date(s) of the various visas and immigration applications of the employees. As yet another alternative (possibly in conjunction with one of the embodiments already described), the database 410 may be constructed as a set or sets of entries that become linked (e.g., using a database program in essentially real-time) responsive to input queries and/or stipulations. In this manner, employer and/or employee entries become linked based on the input criterion or criteria as needed.

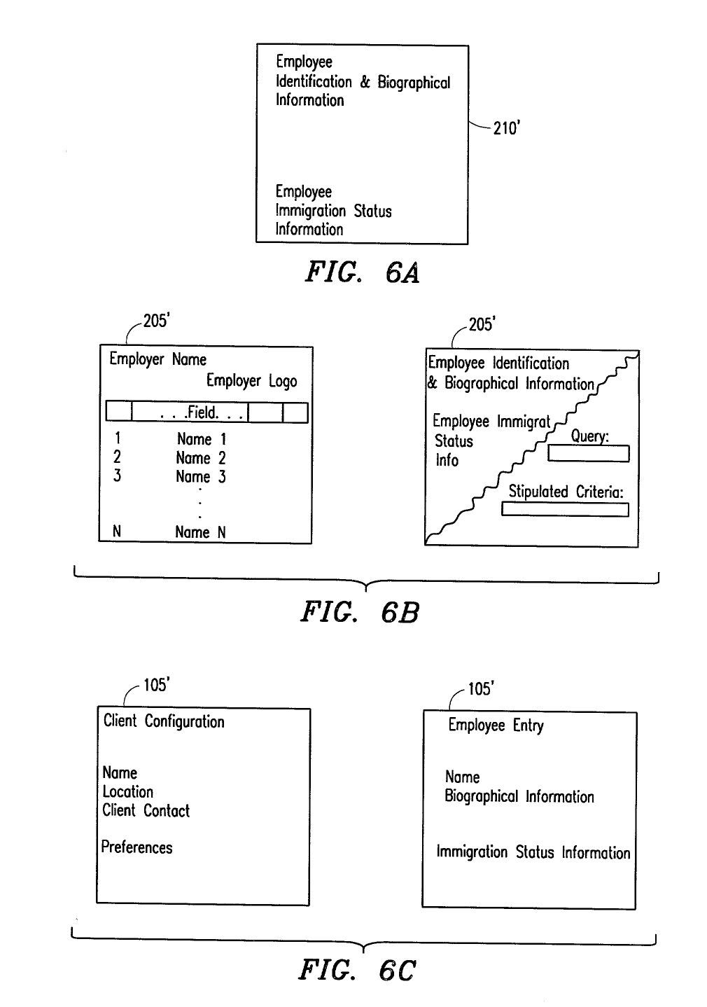

Referring now to FIGS. 6A, 6B, and 6C, exemplary terminal screen views for providing immigration status information in accordance with the present invention are illustrated at 210′, 205′, and 105′, respectively. These exemplary screen views may be printed, for example, by the relevant viewer in a “screen dump” format, using a standard browser print feature, in a “printer friendly” format, etc. Additional exemplary screen views are described further hereinbelow and illustrated in subsequent drawings. On the employee terminal 210′ (of FIG. 6A), employee identification and biographical information may be displayed along with the particular employee's immigration status information. On the employer terminal 205′, multiple screens may be viewed. For example, the left screen of FIG. 6B displays the employer name and logo along with a listing of all of the employer's employees that are entered into the system. The employees' entries that are listed may be ranked/ordered, for example, using any of the fields displayed therefor (e.g., alphabetically by name, chronologically by expiration date, numerically by social security or employee number, etc.) The right screen of FIG. 6B displays two possible additional exemplary screens. The top portion illustrates a display of a single employee's immigration status information details (e.g., optionally similar to employee terminal 210′ of FIG. 6A) while the bottom portion illustrates a display of a search filter that may selectively focus on certain employees' entries based on that which is requested. The requested information may be input using, for example, a query format, a stipulated criterion/criteria format, etc.

Additionally, on the service provider terminal 105′ (of FIG. 6C), multiple screens may be viewed. For example, the left screen of FIG. 6C displays a client configuration screen that may be used to create and/or edit an employer's account and/or collection of entries in the system, including, by way of example only, the name, location, client contact, and the preferences selected by and instituted for this client. The right screen of FIG. 6C, on the other hand, displays an employee (e.g., immigrant) entry configuration screen that may be used to create and/or edit a particular employee's data, including, by way of example only, name, biographical information, and immigration status information.

Advantageously, embodiment(s) of the present invention may be applied to/utilized in environments in which the services being provided by the service provider involve, and/or are related to, immigration law. Legal immigration in the U.S. is a highly regulated and tightly controlled system that serves the national interest. Through this legal immigration system, U.S. citizens and lawful permanent residents unite with close family members, and U.S. employers gain access to the specific skills necessary to strengthen the U.S. economy and remain competitive in the global economy. Through legal immigration, the U.S. also fulfills its longstanding tradition of protecting a fraction of the world's refugees. Legal immigration is thus good for America—citizens and immigrants alike.

A legal immigrant, as a current example, is a foreign-born individual who has been admitted to reside in the U.S. as a lawful permanent resident (LPR). LPRs are given immigrant visas, commonly referred to as “green cards.” Nonimmigrants (e.g., aliens), on the other hand and also as a current example, are foreign-born individuals who are permitted to enter the U.S. for a limited period of time, and they are given only temporary (nonimmigrant) visas. Examples of nonimmigrants include, but are not limited to, students, tourists, temporary workers, business executives, and diplomats. Through employment-based immigration, a U.S. employer can sponsor a foreign-born employee for permanent residence. Typically, in accordance with current laws and regulations, such an employer first demonstrates to the Department of Labor that there is no qualified U.S. worker available for the job for which an immigrant visa is being sought. Employment-based immigration is currently limited by statute to a set number of persons per year. In most cases, before the Immigration and Naturalization Service (INS) will issue an employment-based immigrant visa to a foreign-born individual, the employer first obtains a “labor certification” from the U.S. Department of Labor confirming that there are an insufficient number of U.S. workers able, qualified, and willing to perform the work for which the foreign-born individual is being hired. The Department of Labor also confirms that employment of the foreign-born individual will not adversely affect the wages and working conditions of U.S. workers. This type of labor certification process takes an average of two (2) years to complete.

Notably, the principles of the present invention are applicable to both inbound (e.g., employing foreign workers in the U.S.) and outbound (e.g., sending U.S. workers abroad) immigration services. With regard to inbound immigration services, the present invention may be utilized to provide immigration status information that relates to, for example, the following nonimmigrant visa petition proceedings:

H-1B Specialty Occupation Worker visa petitions, including the Labor Condition Application filings, and required wage determinations

L-1A Intracompany Transferee executive and manager visa petitions

L-1B Intracompany Transferee specialized knowledge visa petitions

L-1 Blanket Petitions at U.S. consular posts abroad

E-1/E-2 Treaty Trader and investor visa applications

Change of Nonimmigrant Status filings

Utilization of J-1 Exchange Visitor Programs, and waiver of the two year home country physical presence

O-1 Alien of Extraordinary Ability and P-1 Professional Athlete and performer visas

Consular Law

TN visas for citizens of Canada and Mexico pursuant to the North American Free Trade Agreement

With further regard to inbound immigration services, the present invention may be utilized to provide immigration status information that relates to, for example, the following immigrant proceedings:

Priority Worker Petitions for multinational executives and managers, outstanding researchers and professors, and aliens of extraordinary ability

Employment-Based Immigrant Visa Petitions

Reduction in Recruitment (“RIR”) Alien Employment Certification Applications

Individual Labor Certification Applications

Adjustment of Status Applications filed with the Immigration and Naturalization Service in the United States (USINS), and Consular Processing for immigrant visas issued abroad

With still further regard to inbound immigration services, the present invention may be utilized to provide immigration status information that relates to, for example, the following enforcement proceedings:

I-9 Employment Eligibility Verification audits and compliance counseling

H-1B public access file creation, maintenance, and audits

Defense of administrative and judicial enforcement actions under IRCA, and ACWIA

Unlawful immigration and related employment discrimination defense

And with regard to outbound immigration services, the present invention may be utilized to provide immigration status information that relates to, for example, the various immigration programs/proceedings offered by other countries.

It should be understood that the immigration services, visa types, relevant statuses thereof, etc. that are described herein are non-exclusive and are exemplary only. For example, other visas may include B-1, B-2, Visa Waiver Pilot Program, H-3, DV, F-1, H-4/L-2 dependents, P-2/P-3, etc. Embodiment(s) of the present invention may provide status information that relates to, for example, only a subset of those described herein, others that are neither mentioned nor described herein, some combination thereof, etc. Also, the status information may pertain to, for example, whether an application is pending, what stage an application is in, a date of filing for an application, a beginning date for a visa type, a termination date for a visa type, the next due date for submitting information, the next paper/information that needs to be submitted (e.g., a standard petition name, a listing of information needed from the employee, etc.), vital information for the employee, etc. Other examples are described hereinbelow.

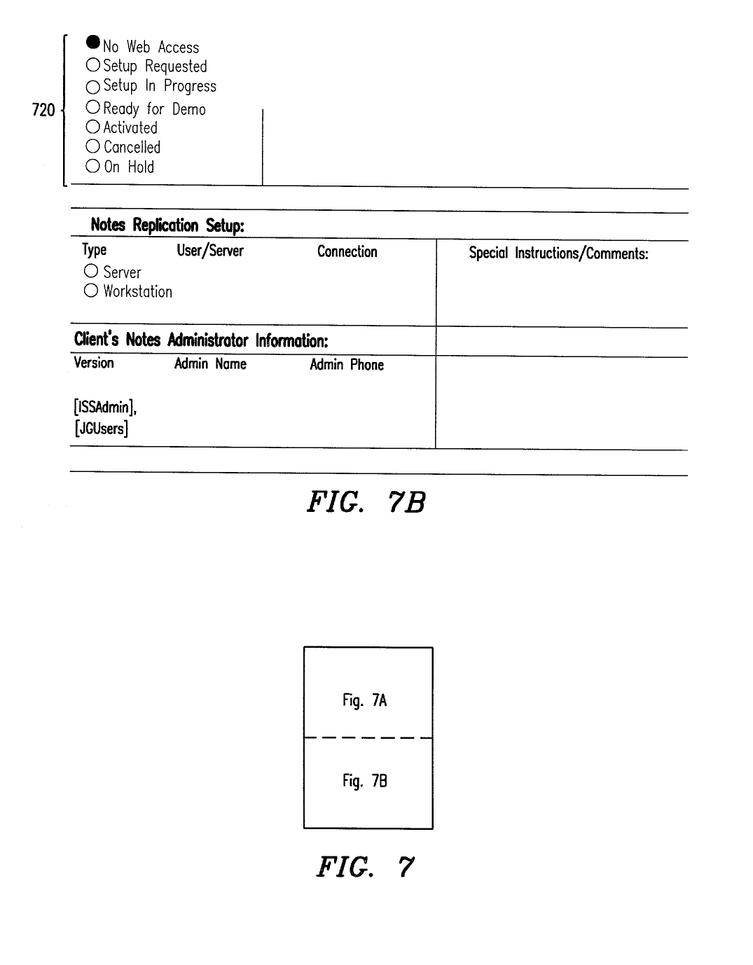

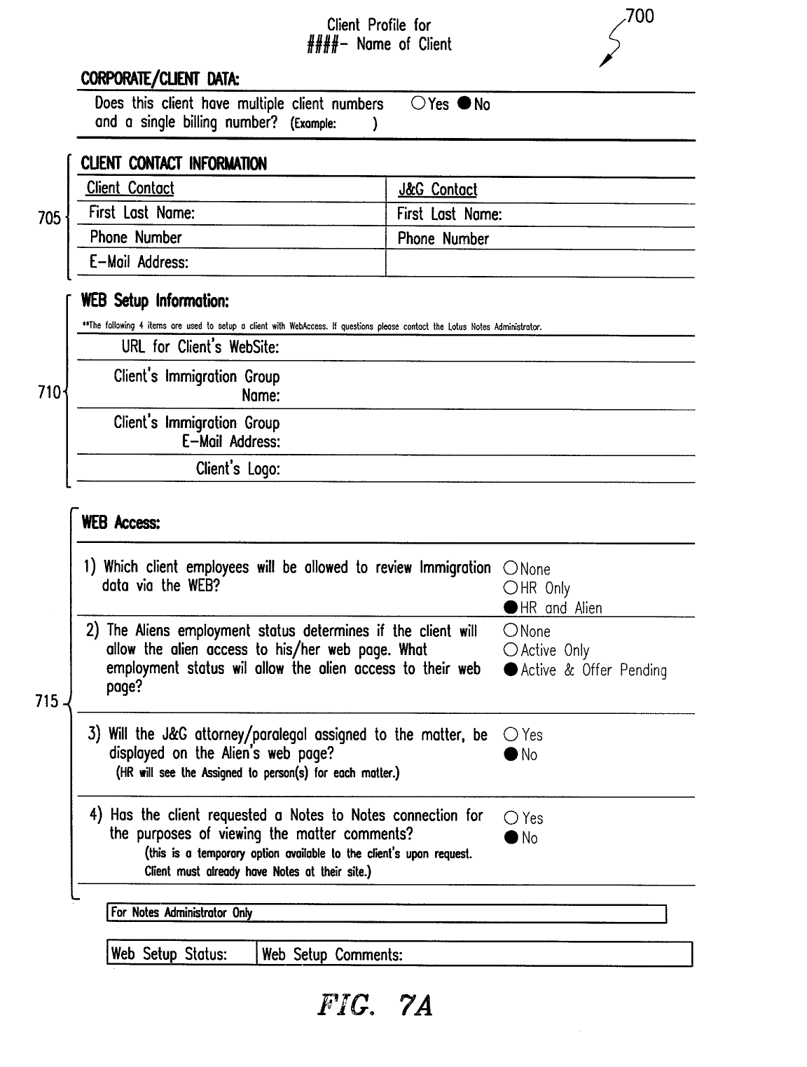

With reference now to FIGS. 7, 7A, and 7B, an exemplary client profile screen in accordance with the present invention is illustrated generally at 700. It should be understood that other information (more, less, different, etc. information and/or fields) and/or other layout(s) may be selected and utilized for a client profile without departing from the spirit and scope of the present invention.

The exemplary client profile 700 may be initially prepared when a client determines that it wishes to participate in the immigration status system. Contact information may be provided at area 705. Web setup information may be provided at area 710. The web setup information may include an e-mail address for the client's immigration group (e.g., all or part of an HR department), acquisition of the client's logo for display when the HR department and/or employees access the immigration status system, etc.

Web access rules may be selected at area 715. The following web access business rules may be utilized for the convenience of the participants, as usually selected by the client: These business rules may, for example, be implemented at the client level for each client. The client may have three (3) levels of web access allowed: None, HR Only, or HR and Alien. In certain embodiment(s), all clients and all related matters are set to None by default.

The client may provide its access rules to select a web access level other than None. The determination may be based on the value of the “Alien Access” and “Matter Access” fields of the Client Profile. The “Alien Access” field may have (2) choices: Active Only or Active and Offer Pending. In certain embodiment(s), the default is Active Only. The “Matter Access” field may have two (2) choices: All Matters or Exclude General Matters. In certain embodiment(s), the default is All Matters. Table 1 below indicates an exemplary set of available business rules:

TABLE 1
Exemplary Available Business Rules

| None * | HR Only | HR and Alien |
|---|---|---|
| All Matters | All Matters * | All Matters * |
| | Exclude General | Exclude General |
| | Matters | Matters |
| | | Active Only |
| | | Active & Offer Pending |

With reference to Table 1, “None” implies that the client does not have web access. In certain embodiment(s), by default the web access on all matters is set to None. “HR Only” implies that the selected HR staff of the client has web access. In certain embodiment(s), by default, web access for all Alien and General Matters is set to HR Only. Alternatively, the client may elect to view only Alien Matters or only General Matters. Aliens do not have web access under HR Only. “HR and Alien” implies that both the selected HR staff and the alien employees of the client have web access.

With continuing reference to Table 1, certain embodiment(s), by default, provide the HR department with access to all Alien and General Matters. The client may elect to exclude the General Matters. With respect to aliens, certain embodiment(s), by default, provide aliens with access to only their own information as long as they are an Active employee of the client. In these embodiment(s), aliens with an employee status of “Offer Pending” or “Terminated” do not have web access. Alternatively, the client may elect to allow aliens that are in “Offer Pending” status to have web access.

Thus, in certain exemplary embodiment(s), web access may be set to None, HR Only, or HR and Alien. If the web access is set to HR Only, then the HR department's web access may be set for All Matters or only for Immigration-Related Matters. If, on the other hand, the web access is set to HR and Alien, then the HR department's access may be set for All Matters or only for Immigration-related Matters while the aliens' web access may be set for Active Only or Active & Offer Pending.

As another exemplary applicable business rule that may be implemented on behalf of the client for each client, the client has an option of displaying the attorney's (or paralegal's, etc.) name assigned to a matter on the particular alien's immigration status information web page when the alien is viewing same. However, this feature may be turned on or off at the client level of the system via a Display Attorney field of the Client Profile. The Display Attorney field, has an exemplary two (2) options: YES or NO. In certain embodiment(s), the default is set to NO, and the assigned to person(s) are not presented to the alien. If YES is selected, on the other hand, then the assigned to person(s) for a particular matter is displayed on the particular alien's web page.

It should be noted that, with regard to question four (4) in the area 715, other embodiment(s) may enable viewing of the comments, which are prepared by the service provider, by a client without using a Notes-to-Notes connection. The web setup status for the particular client is determined by the “radio button” selector at area 720. As is described in greater detail hereinbelow, the setup process can progress through multiple stages as the database is readied, the client is trained, information is attained and added to the database, etc.

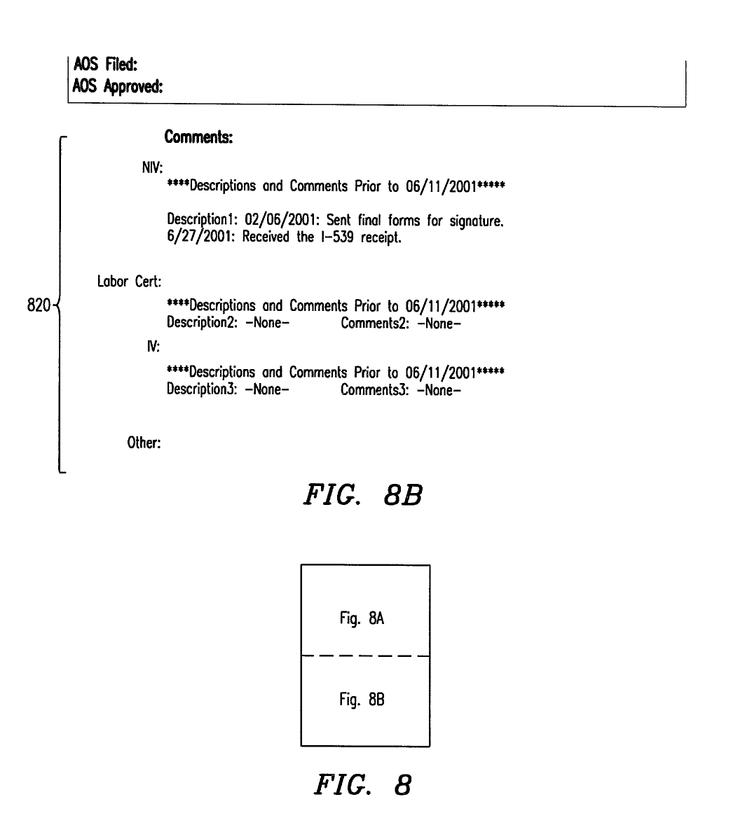

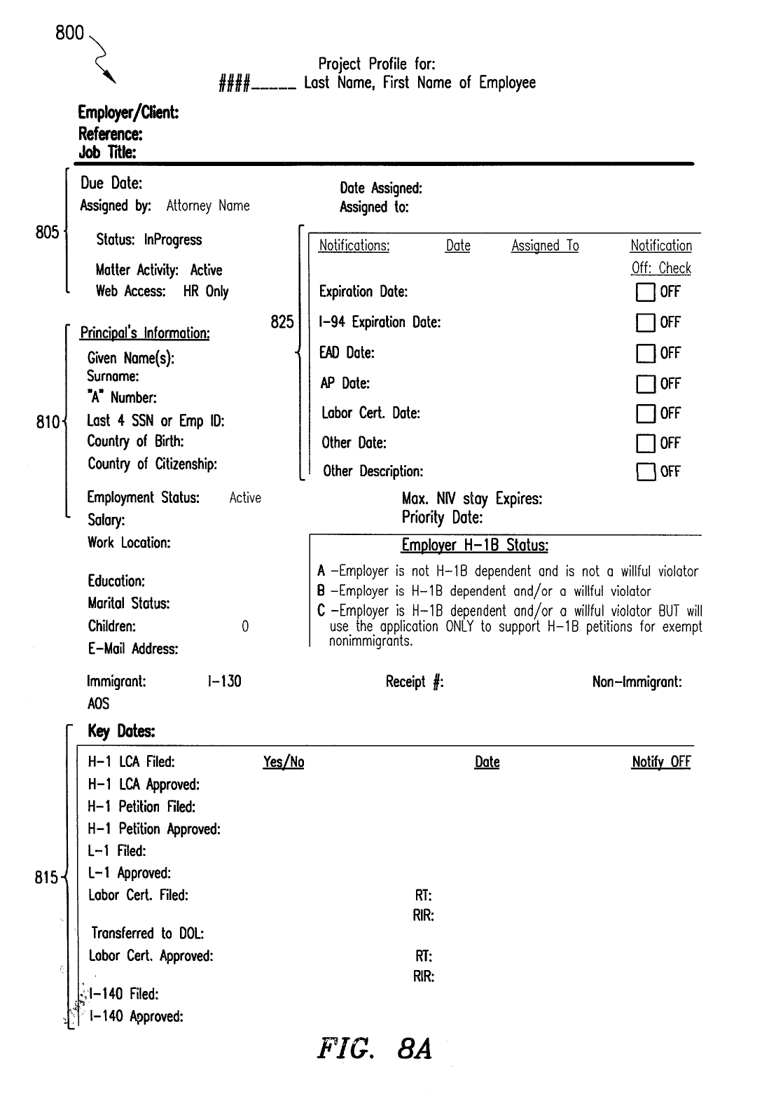

Referring now to FIGS. 8, 8A, and 8B, an exemplary project profile screen in accordance with the present invention is illustrated generally at 800. It should be understood that other information (more, less, different, etc. information and/or fields) and/or other layout(s) may be selected and utilized for a project profile without departing from the spirit and scope of the present invention. The exemplary project profile 800 may be initially prepared when a client requests that a new employee be added to the immigration status system. Area 805 may include service provider and immigration status system type information for the project profile 800. Employee information (e.g., name, vital statistics, biographical information, family information, etc.) may be included in area 810. Key dates for any relevant immigration applications (e.g., visas applied for, forms filed, etc.) may be included in area 815.

In the area 820, comments may be inserted by personnel (e.g., attorney, paralegal, etc.) of the service provider. These comments may be date relevant, may be directed to particular immigration types, may be general in nature, etc. Advantageously, certain embodiment(s) of the present invention enable these comments to be accessible by the HR department and/or the particular employee. The feature may, for example, be selected by the client and activated by the service provider. A listing of relevant immigration applications and optional notifications related thereto are presented in area 825. Each relevant immigration application type may be related to a due date, an assigned to person, and a notification check box. In the exemplary project profile 800, the default notification check is for the notification to be on. The notification may, however, be turned off. Alternatively, the default notification check may be for the notification to be off. When the notification is on, notification e-mails may be sent to the assigned to person periodically (e.g., two months before due date, one month before due date, two weeks before due date, and then daily thereafter) until the relevant task is completed and/or the notification check is turned off.

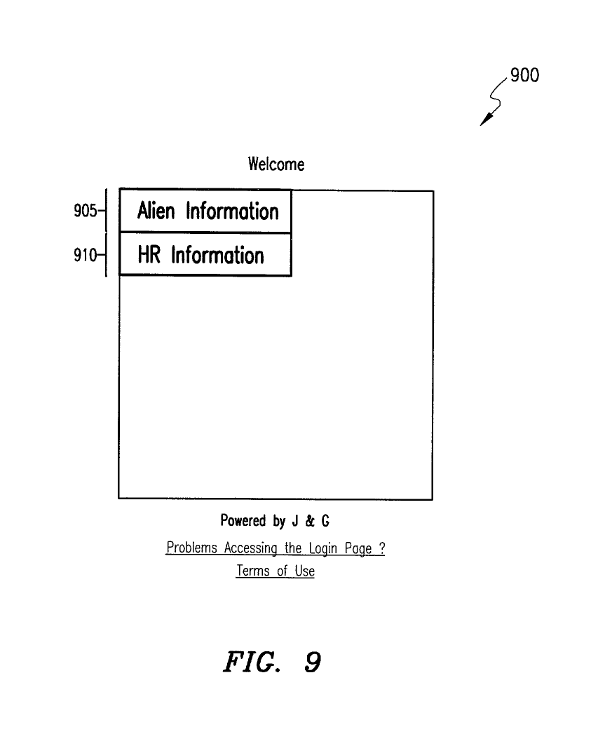

With reference now to FIG. 9, an exemplary starting web page for providing immigration status information in accordance with the present invention is illustrated generally at 900. The exemplary starting web page 900 may include links to a page helping with problems accessing a login page and to a page describing the terms of use. Also, it may include an alien information area 905, which serves as a link for aliens to use to access web page(s) providing their respective particular immigration status information. Furthermore, the exemplary starting web page 900 may include an HR information area 910, which serves as a link for HR departments to use to access web page(s) providing immigration status information of the employees of the respective HR departments.

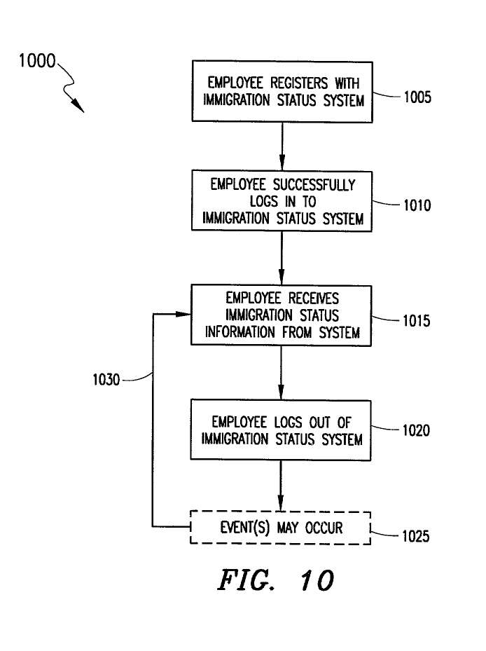

With reference now to FIG. 10, a method in flowchart form for providing immigration status information to an employee in accordance with the present invention is illustrated generally at 1000. Once the service provider has prepared and activated an employee profile (e.g., such as the project profile 800 of FIGS. 8, 8A, and 8B), the employee may register with the immigration status system for access thereto. Optionally, the employee may be sent an e-mail by the service provider notifying him or her that the system is ready for his or her registration. The employee thus registers with the immigration status system (step 1005). Thereafter, the employee may, at his or her convenience, successfully log into the immigration status system (step 1010). This logging into the immigration status system may be effectuated over an electronic medium such as that illustrated in FIG. 4 and described in the related text, for example. Likewise, the employee may electronically receive (and have displayed on a terminal, printed out, etc.) immigration status information pertaining to him or her from the system (step 1015).

After reviewing the received immigration status information (and, e.g., noting any new changes thereto), the employee may log out of the immigration status system (step 1020). While the employee is not logged into the system, for example, one or more of multiple event(s) may occur (step 1025). The service provide may receive/determine/etc. updated immigration status information for the particular employee (e.g., from a communication with a governmental entity). The service provider would therefore update the immigration status information pertaining to the particular employee. The service provider may also optionally send a notification e-mail to the particular employee upon updating his or her immigration status information. Responsive to such an e-mail or sua sponte on the part of the employee (as represented by the arrow 1030), the employee may again successfully log into the immigration status system (at step 1010). The employee then receives the updated immigration status information from the system (at step 1015).

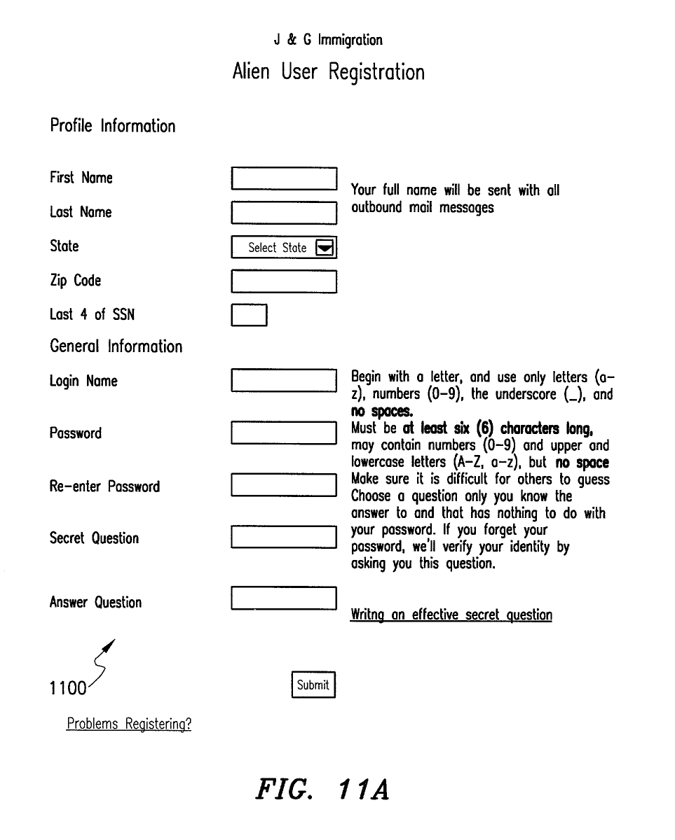

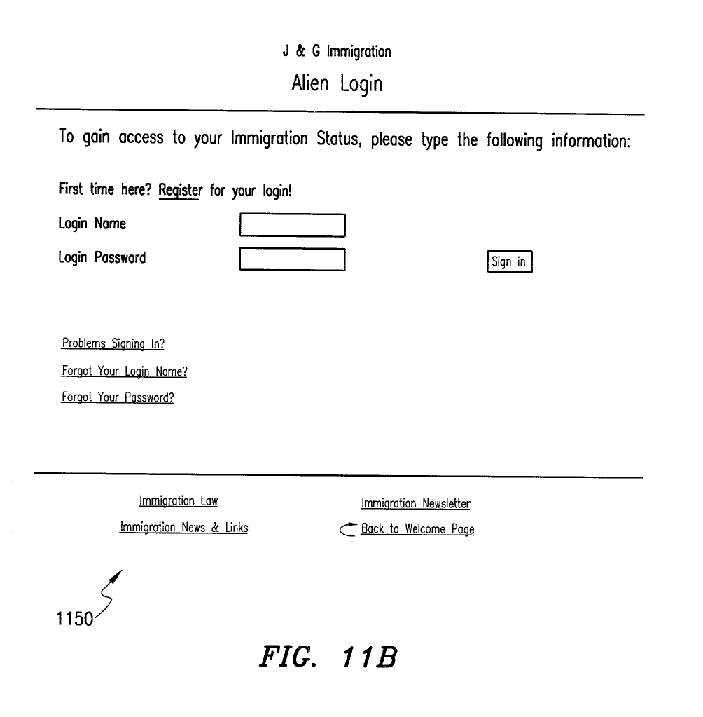

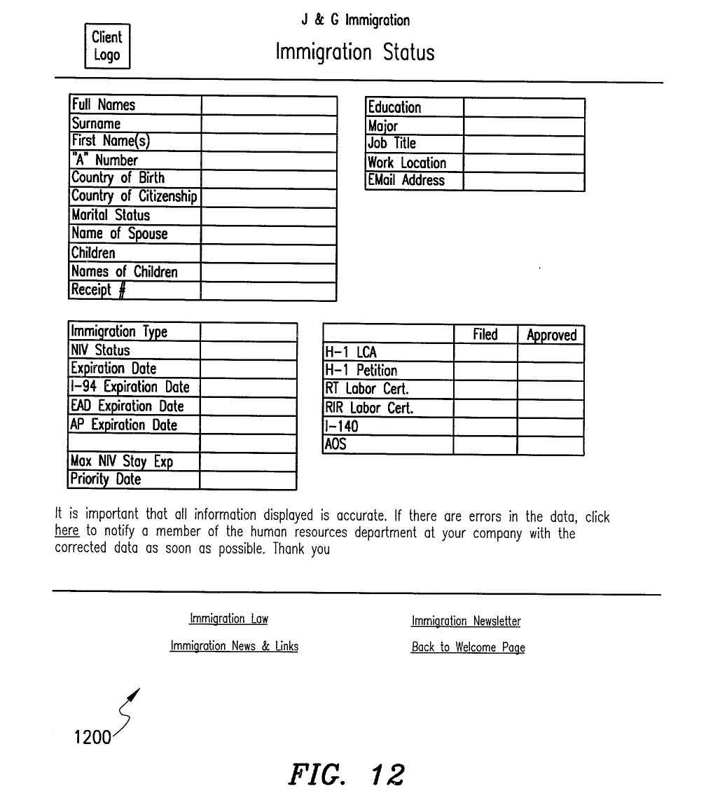

With reference now to FIGS. 11A and 11B, exemplary web pages for alien user registration and alien login, respectively, in accordance with the present invention are illustrated generally at 1100 and 1150. The exemplary alien user registration web page 1100 may be utilized to accept information from an employee in order to provide future access to the immigration status system. This information may include authentication information so as to ensure that access to an employee's information is only being provided to the employee, login information that may be used in subsequent logins, etc. The exemplary alien login web page 1150 may be utilized to provide current access to the immigration status system. Proper login results in the presentation to the employee of his or her current immigration status information.

With reference now to FIG. 12, an exemplary web page for providing immigration status information to an alien in accordance with the present invention is illustrated generally at 1200. The exemplary immigration status information web page 1200 may be presented to an employee after the employee has successfully logged into the immigration status system. The exemplary immigration status information web page 1200 displays exemplary information pertaining to the particular employee. It should be understood that other information (more, less, different, etc. information and/or fields) and/or other layout(s) may be selected and utilized for an immigration status information web page without departing from the spirit and scope of the present invention. This information includes name/biographic information in the top left and education/work information in the top right. This information also includes immigration information such as expiration dates (e.g., for I-94, EAD, AP, etc.), application filing/approval dates (e.g., H-1, RT labor certification, I-140, etc.), and/or status/type data, etc. in the bottom half of the immigration status information web page 1200.

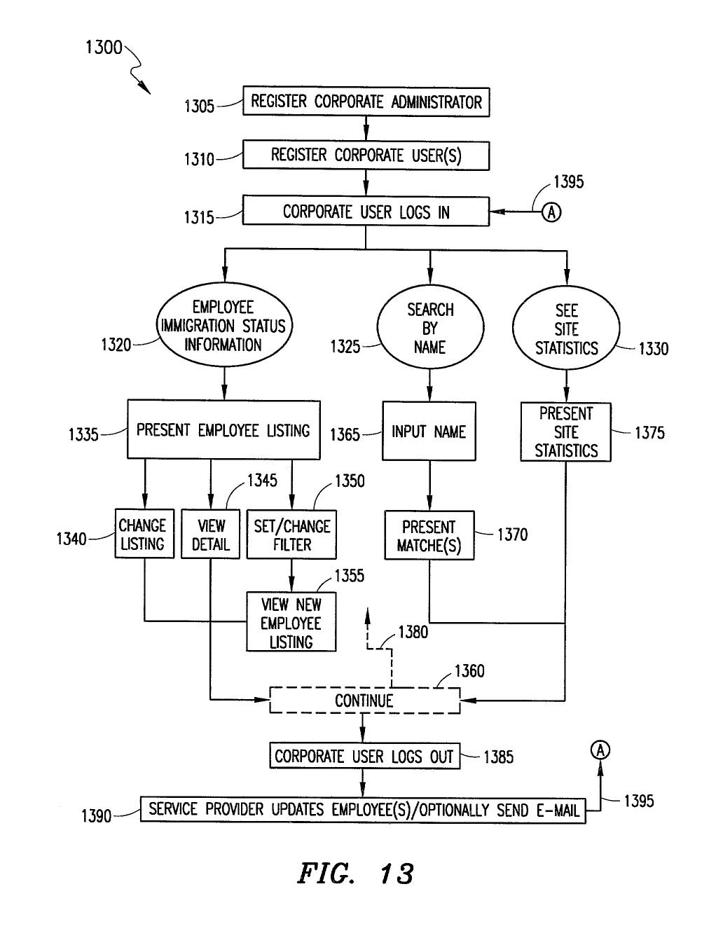

With reference now to FIG. 13, a method in flowchart form for providing immigration status information to an employer in accordance with the present invention is illustrated generally at 1300. Once the service provider has prepared and activated an employer profile (e.g., such as the client profile 700 of FIGS. 7, 7A, and 7B), the designated corporate administrator of the employer may register with the immigration status system for access thereto. Optionally, the service provider may send the corporate administrator an e-mail notifying him or her that the system is ready for his or her registration. The corporate administrator thus registers with the immigration status system (step 1305). Each client may establish a corporate administrator who controls which people of the employer (e.g., of the HR department) is granted access as an employer to the immigration status system. These people of the employer are designated as, and set up in the system as, corporate user(s).

These corporate user(s) register with the immigration status system at their convenience (and/or responsive to a notification e-mail) to gain access thereto (step 1310). Thereafter (optionally after the service provider has fully activated access because of the registration), a given corporate user may, at his or her convenience, successfully log into the immigration status system (step 1315). This logging into the immigration status system may be effectuated over an electronic medium such as that illustrated in FIG. 4 and described in the related text, for example. Likewise, the corporate user may electronically receive (and have displayed on a terminal, printed out, etc.) immigration status information (including web pages) pertaining to his company and/or the employees thereof (steps 1320, 1325, and 1330, et seq.).

In certain embodiment(s), the corporate user may choose from at least three (3) options (of steps 1320, 1325, and 1330, et seq.). For instance, the corporate user may select to see employee immigration status information (e.g., a status listing) (step 1320). Responsive to the corporate user's selection of an appropriate link, for example, the service provider presents an employee listing (step 1335).

The corporate user may view the employee listing, in which possibly only a portion of the total number of statuses are viewable at once due to screen size constraints. The corporate user may cause the listing to be changes (step 1340). This listing may be changed by incrementing or decrementing the listing by one (1) (e.g., a view of employees 23-32 may be changed to employees 22-31 or 24-33, etc.). Alternatively, the listing may be changed by moving one (1) page in either direction (e.g., a view of employees 23-32 may be changed to employees 13-22 or 33-42, etc.). Or the listing may be changed by moving to the first or last employee entry (e.g., a view of employees 23-32 may be changed to employees 1-10 or (x-10)-x, where x is the total number of employee entries, etc.) Other listing changes may be used also or instead.

The corporate user may instead (after step 1335) cause a detail view of an employee entry to be displayed (step 1345). This detail view may include immigration status information (and identification/biographic information) similar or identical to that displayed to the particular employee when he or she logs in. The corporate user may also move from one detailed view to another. The corporate user may still further instead (after step 1335) cause a filter to be set or changed (step 1350). The filter establishes user selectable requirements that an employee entry must meet in order to be listed in an employee listing view. Various exemplary filter options are described further hereinbelow. After the filter has been set/changed (at step 1350), the new employee listing is presented by the service provider and may be viewed by the corporate user on his or her terminal (step 1355). After any of steps 1340, 1345, and 1355, the corporate user may elect to continue to use the status immigration system (step 1360).

When the corporate user is choosing from the exemplary at least three (3) options (of steps 1320, 1325, and 1330, et seq.), the corporate user may instead select to search by name in the employees of the employer (step 1325). This alien user administration enables the corporate user to quickly find a desired employee entry, for example. After the corporate user inputs all or part of the name of a desired entry or entries (step 1365), the service provider's immigration status system presents one or more match(es) (step 1370). The listing of actual and/or potential match(es) may include information besides the name such as employee status, web access, registration date, etc. The corporate user may elect to view detailed information of any or all entries presented in the match list.

When the corporate user is choosing from the exemplary at least three (3) options (of steps 1320, 1325, and 1330, et seq.), the corporate user may instead select to see the site statistics for all employee entries of that particular employer (step 1330). This option enables the corporate user to gain a quick understanding of the overall trends, etc. of the aliens employed by the employer after the service provider's immigration status system presents the site statistics. Various exemplary statistics are described further hereinbelow. After either of steps 1370 and 1375, the corporate user may elect to continue to use the status immigration system (step 1360). In effect, the corporate user may elect to continue at any of steps 1320-1375 (as indicated by dashed arrow 1380) depending on, for example, the step(s) taken to reach the continuation step 1360 and the corporate user's navigation of the web pages of an exemplary immigration status system web site (e.g., various links, back button opportunities, etc.).

Continuing with the flowchart 1300, if the corporate user elects to not continue (at step 1360), then the corporate user may log out of the system (step 1385). While the corporate user is logged out of the system (although it should be noted that in certain embodiment(s) entries of employees of the corporate user's employer may be updated while the corporate user is logged in) (after step 1385), the service provide may update one or more entries of employees of the corporate user's employer (step 1390). This may occur as new information is received (e.g., from a governmental entity), as dates change or elapse, etc. Upon a change to an entry to an employee of the employer, the corporate administrator, a general corporate user, all corporate users, a corporate user assigned to the given employee/entry, etc. may optionally be notified by e-mail of the change (also step 1390). The notification may include, for example, all details of the change (and possibly the employee's entire entry), the category and/or type of change only for the employee, only an identification of the affected employee, only an indication that a change for some employee has been made (in which case logging in by the corporate user may cause the system to present a list of all changes since a previous log in), etc. Responsive to such an e-mail or sua sponte on behalf of the corporate user (as indicated by the arrow 1395), the corporate user may again log into the system (at step 1315) and view the updated entries.

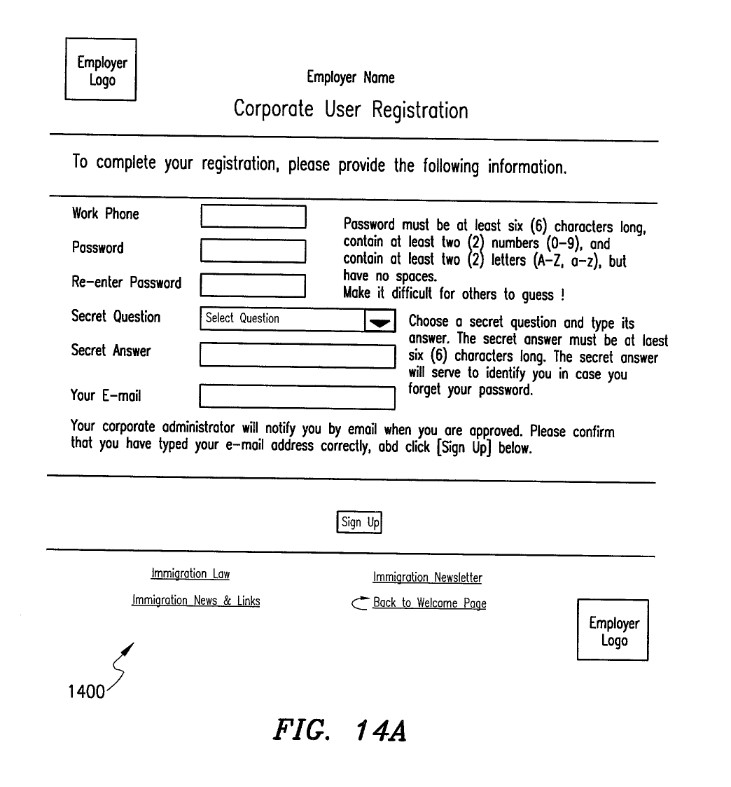

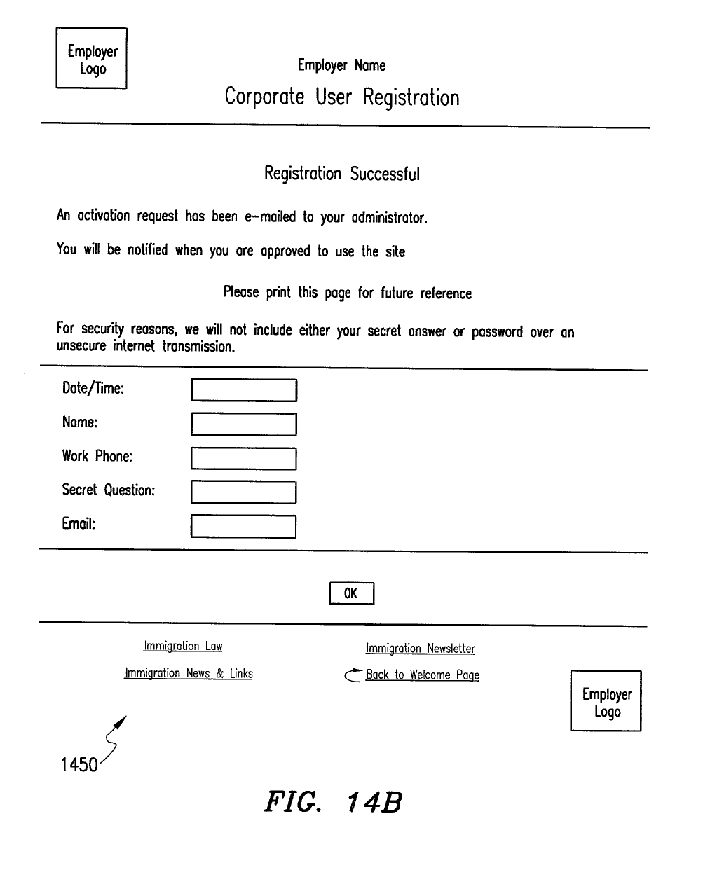

With reference now to FIGS. 14A and 14B, exemplary web pages for corporate user registration and corporate user registration submission acknowledgment, respectively, in accordance with the present invention are illustrated generally at 1400 and 1450. To register on an immigration status system as a corporate user, for example, an exemplary corporate user registration web page 1400 may be completed and submitted (e.g., using a browser-based interface) by a would-be corporate user. After submission, an exemplary corporate user registration submission acknowledgment web page 1450 may be presented by the immigration status system to the would-be corporate user. As indicated by the exemplary corporate user registration submission acknowledgment web page 1450, (i) the activation request may be e-mailed to the corporate administrator of the employer, and an e-mail is sent to the would-be corporate user after he or she has been approved to use the immigration status system site and (ii) at least part of the registration information submitted by the would-be corporate user may be re-presented to the corporate user for review and confirmation.

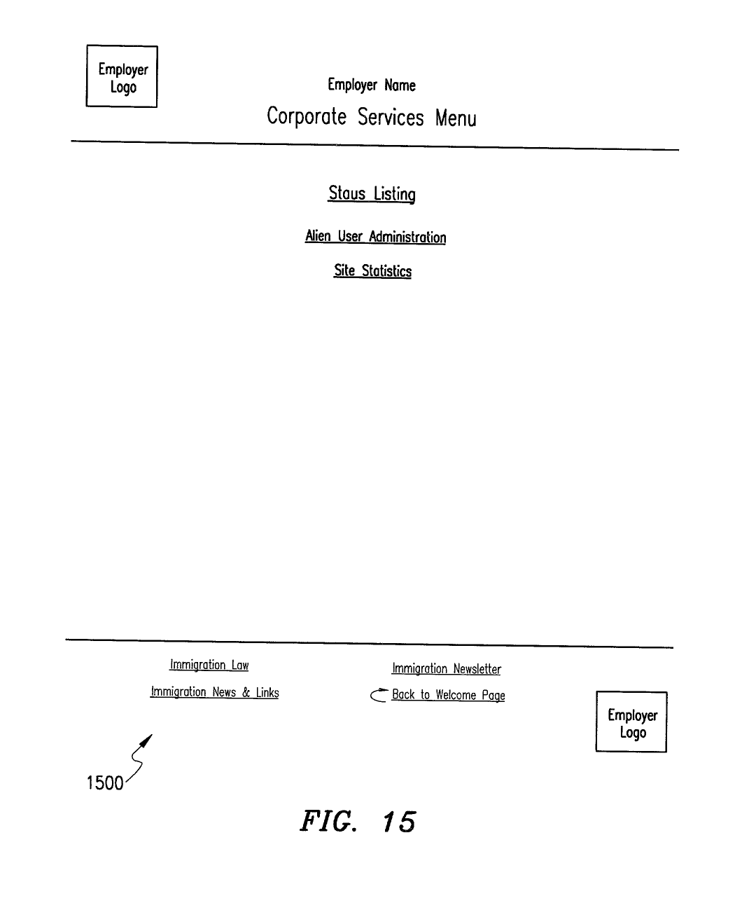

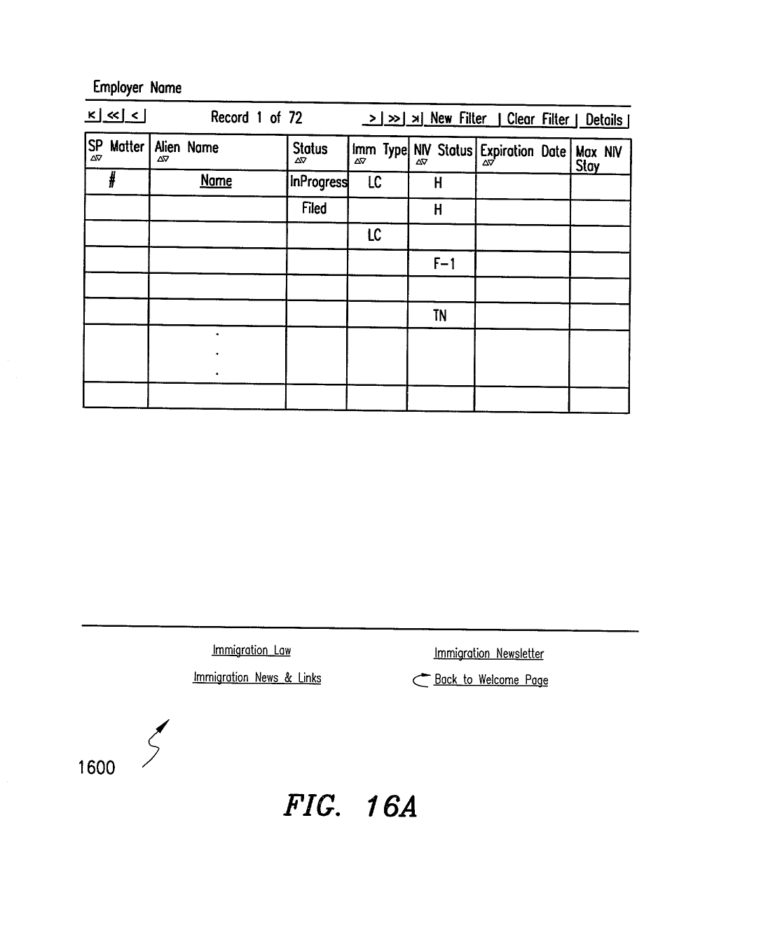

With reference now to FIG. 15, an exemplary corporate services menu web page for providing immigration status information to an employer in accordance with the present invention is illustrated generally at 1500. The exemplary corporate services menu web page 1500 includes the following three (3) exemplary options in the form of links: Status Listing, Alien User Administration, and Site Statistics.

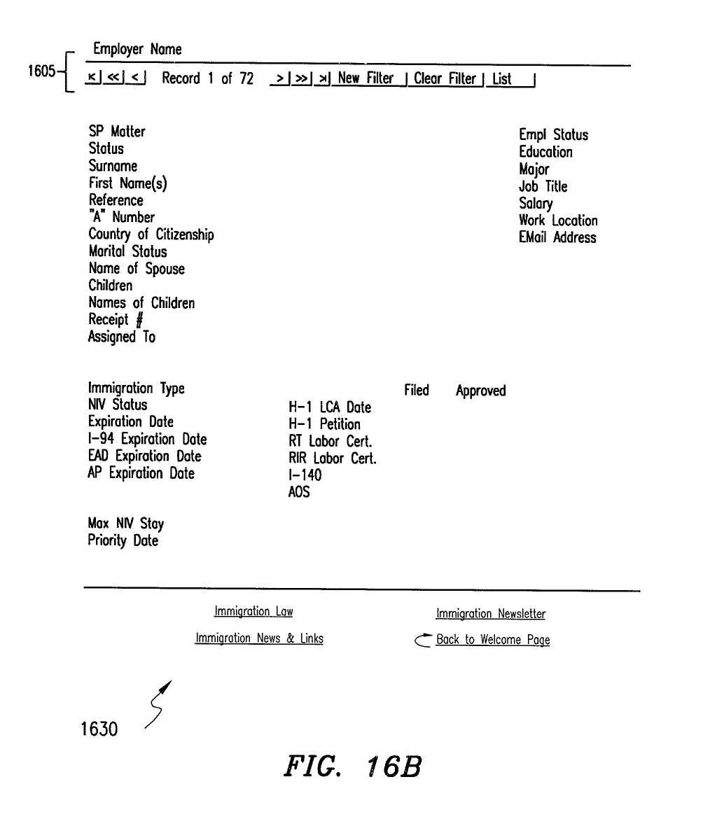

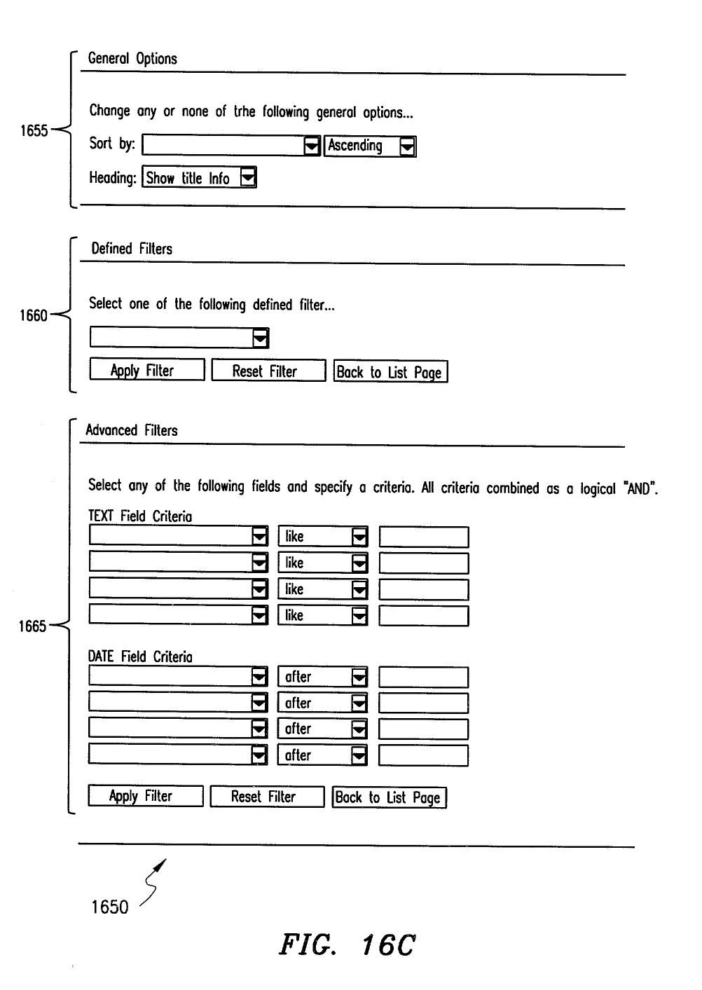

With reference to FIGS. 16A, 16B, and 16C, exemplary aspects of an employee immigration status listing for providing immigration status information to an employer in accordance with the present invention are illustrated generally at 1600, 1630, and 1650, respectively. An exemplary employee immigration status listing web page 1600 includes exemplary navigation/function buttons area 1605, exemplary column heading area 1610, and exemplary employee listing area 1615. The navigation/function buttons of the exemplary navigation/function buttons area 1605 enable a, e.g., corporate user to (from left to right) skip to the first entry, move a page backward, move an entry backward, move an entry forward, move a page forward, move to the last entry, load a filter setting/changing page, clear a current filter setting, and request details of the immigration status information, etc. of a selected employee. The total number of records is also presented in this area.

The column headings of the exemplary column heading area 1610 include (from left to right) : SP (service provider) Matter, Alien Name, Status, Imm Type, NIV Status, Expiration Date, and Max NIV Stay. Each heading may be used to sort the listed employees. Furthermore, the listed employees may be sorted in either direction for each heading, depending on whether a user selects the up or the down pointing triangle.

The exemplary employee listing area 1615 lists each employee as space permits (or at a pre-set number such as 10 or 15 at a time) according to the selected sorting and ordering criteria from the headings and the selected range from the buttons. It should be noted that a particular employee may be selected by, for example, clicking on a (e.g., underlined) name of the employee.

An exemplary detailed employee web page 1630 (of FIG. 16B) illustrates a particular employee's immigration status information (along with biographical information, etc.) Notably, the buttons of the exemplary navigation/function buttons area 1605 may also be presented on the exemplary detailed employee web page 1630 so as to enable movement through the employees of the employer at a detailed level, for example.

An exemplary filter setting/changing web page 1650 (of FIG. 16C) illustrates a portion of the various exemplary manners for filtering through the employees of an employer so as to facilitate the review thereof. In the General Options area 1655, several drop down menus reveal the following exemplary selections:

Sort by:

SP Matter

Status

Matter Name

Surname

First Name

A Number

Country of Birth

Country of Citizenship

Marital Status

Name of Spouse

Number of Children

Receipt #

Assigned To

Employment Status

Education

Major

Job Title

Salary

Work Location

EMail Address

Imm Type

NIV Status

Expiration Date

I-94 Expiration Date

EAD Expiration Date

AP Expiration Date

Other Description

Other Date

Max NIV Stay

Priority Date

H-1 LCA Filed

H-1 LCA Approved

H-1 Petition Filed

H-1 Petition Approved

RT Labor Cert. Filed

RT Labor Cert. Approved

RIR Labor Cert. Filed

RIR Labor Cert. Approved

I-140 Filed

I-140 Approved

AOS Filed

AOS Approved

Heading:

Show Nothing

Show Title Info

Show All Details

“Ascending”:

Ascending

Descending.

And in the Defined Filters area 1660, the drop down menu reveals the following exemplary selections: Defined Filters:

Expired

Expire within 30 Days

Expire within 90 Days

Expire This Calendar Year

Priority Date 30 Days Out.

And in the Advanced Filter area 1665, several drop down menus reveal the following exemplary selections:

TEXT Field Criteria:

SP Matter

1Status

Matter Name

Surname

First Name

A Number

Country of Birth

Country of Citizenship

Marital Status

Name of Spouse

Number of Children

Names of Children

Receipt #

Assigned To

Employment Status

Education

Major

Job Title

Salary

Work Location

EMail Address

Imm Type

NIV Status

Other Description

“like”:

like

exactly

not

DATE Field Criteria:

Expiration Date

I-94 Expiration Date

EAD Expiration Date

AP Expiration Date

Other Date

Max NIV Stay

Priority Date

H-1 LCA Filed

H-1 LCA Approved

H-1 Petition Filed

H-1 Petition Approved

RT Labor Cert. Filed

RT Labor Cert. Approved

RIR Labor Cert. Filed

RIR Labor Cert. Approved

I-140 Filed

I-140 Approved

AOS Filed

AOS Approved

“after”:

after

before

on or after

on or before

between.

It should be understood that other filters and/or filter options may be utilized instead without departing from the principles of the present invention.

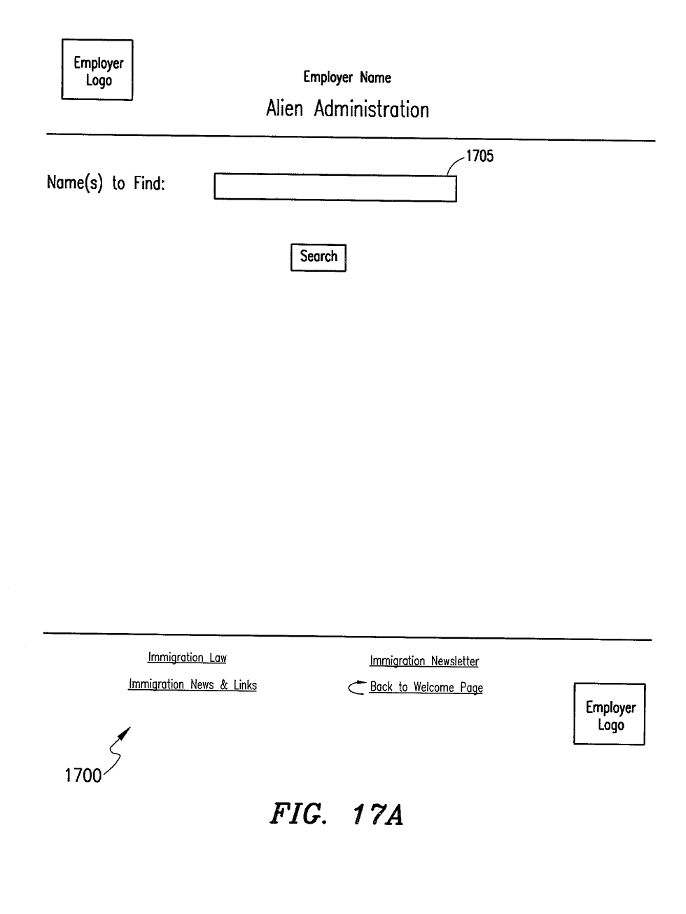

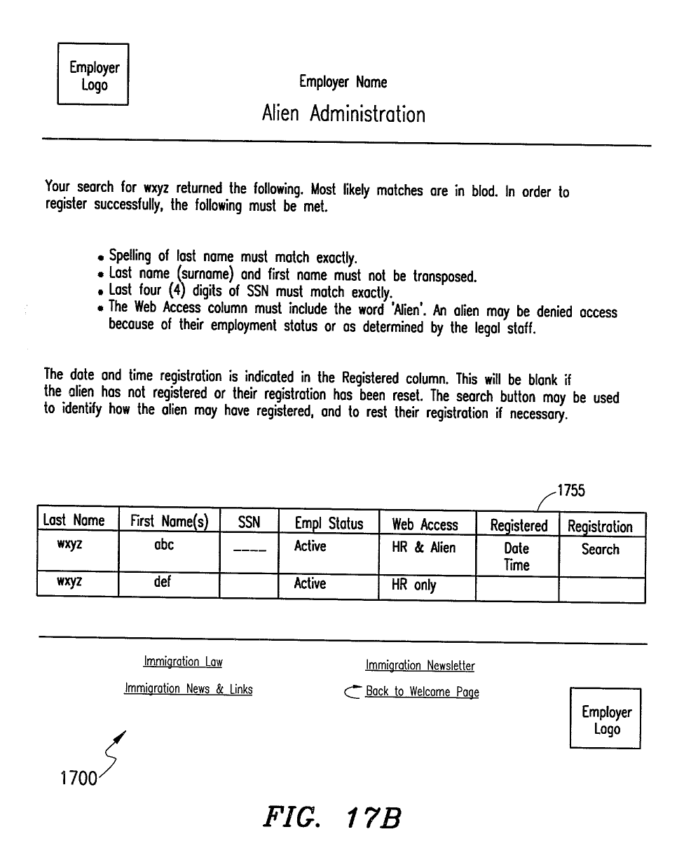

With reference now to FIGS. 17A and 17B, exemplary aspects of an alien administration feature for providing immigration status information to an employer in accordance with the present invention are illustrated generally at 1700 and 1750. An exemplary alien submission name search web page 1700 includes a block for submitting a name to be located among the employees of the employer. Matching results are returned and presented on an exemplary alien search result web page 1750 at, for example, an exemplary results table 1755. The desired employee may be selected and his or her detailed information may be viewed by clicking the appropriate link. This feature may be especially helpful in determining registration status, with the date/time being presented and a button link for additional information also being present in the exemplary results table 1755.

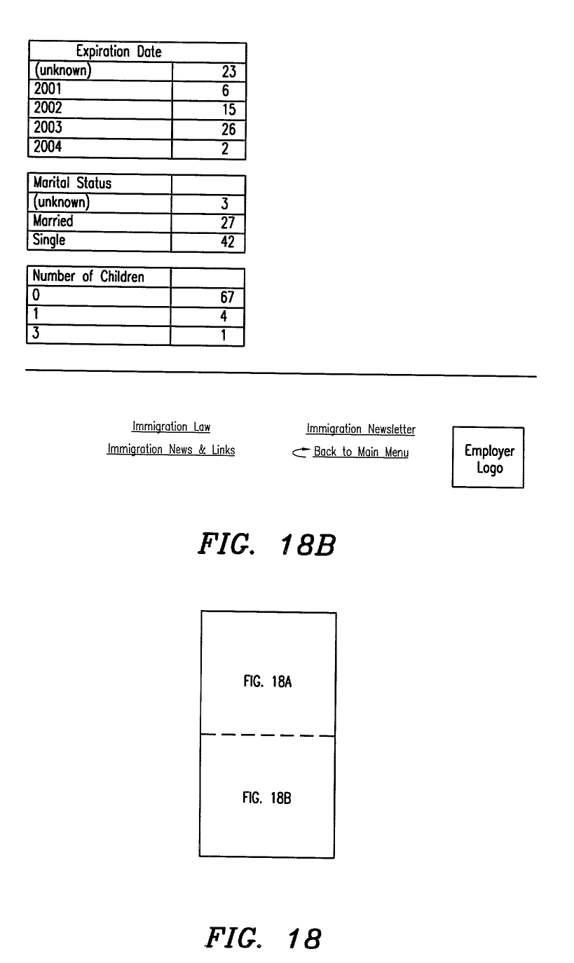

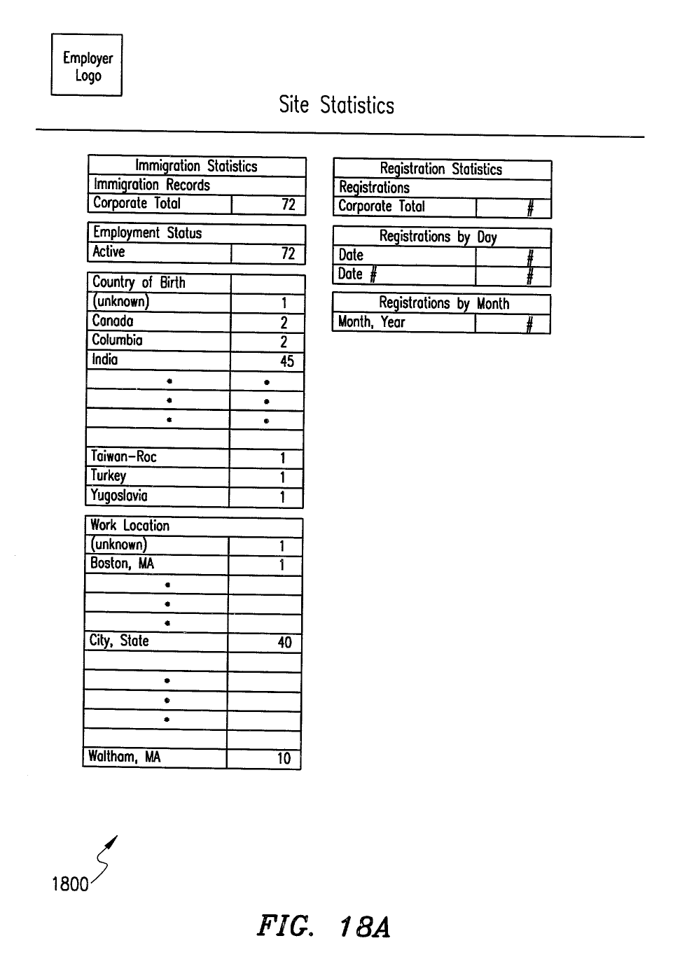

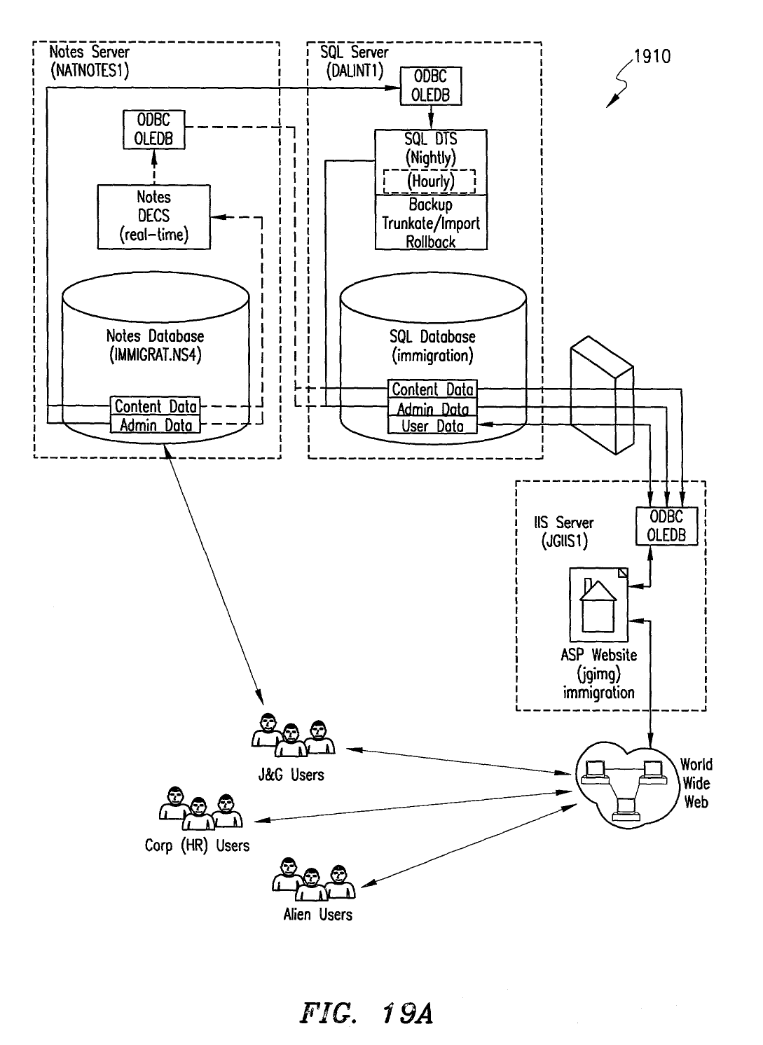

With reference to FIGS. 18, 18A, and 18B, exemplary aspects of a site statistics feature in conjunction with providing immigration status information to an employer in accordance with the present invention are illustrated generally at 1800. An exemplary site statistics web page is illustrated at 1800. Statistics from all or a selected portion of the employees of the employer that are in the immigration status system are gathered and presented in the exemplary site statistics web page. Data may be accumulated and presented for the following exemplary immigration statistics categories: Immigration Records, Employment Status, Country of Birth, Work Location, Expiration Date, Marital Status, and Number of Children. Also, data may be accumulated and presented for the following exemplary registration statistics categories: Registrations, Registrations by Day, and Registrations by Month. It should be noted that the presented categories may be changed, increase, decreased, etc. and that the numbers in FIGS. 18A and 18B are for illustration purposes and therefore individual numbers may not sum to the total number.

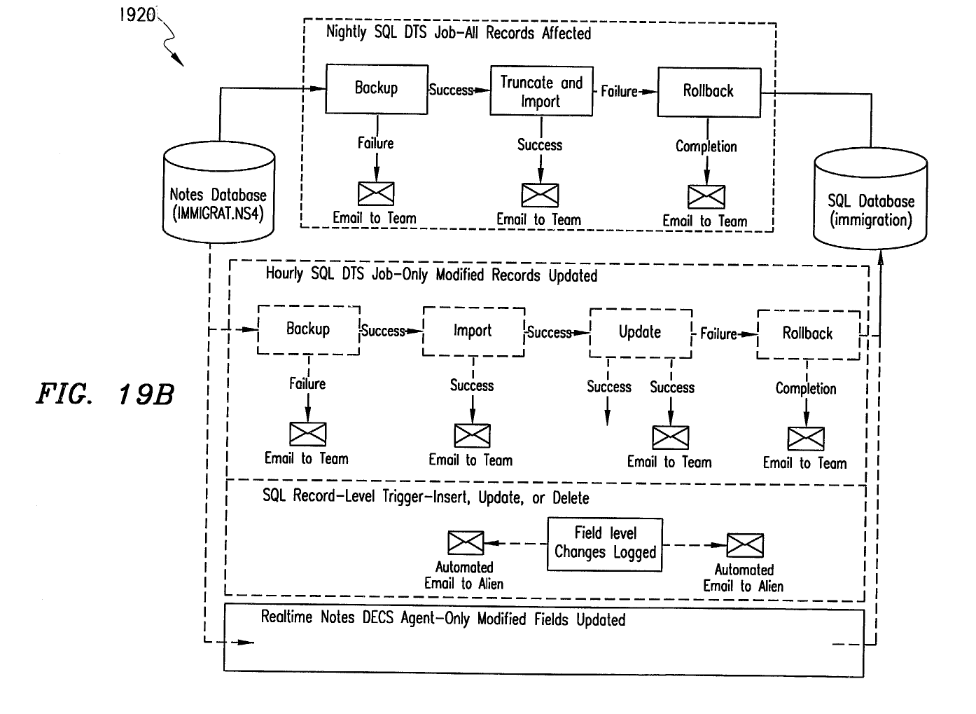

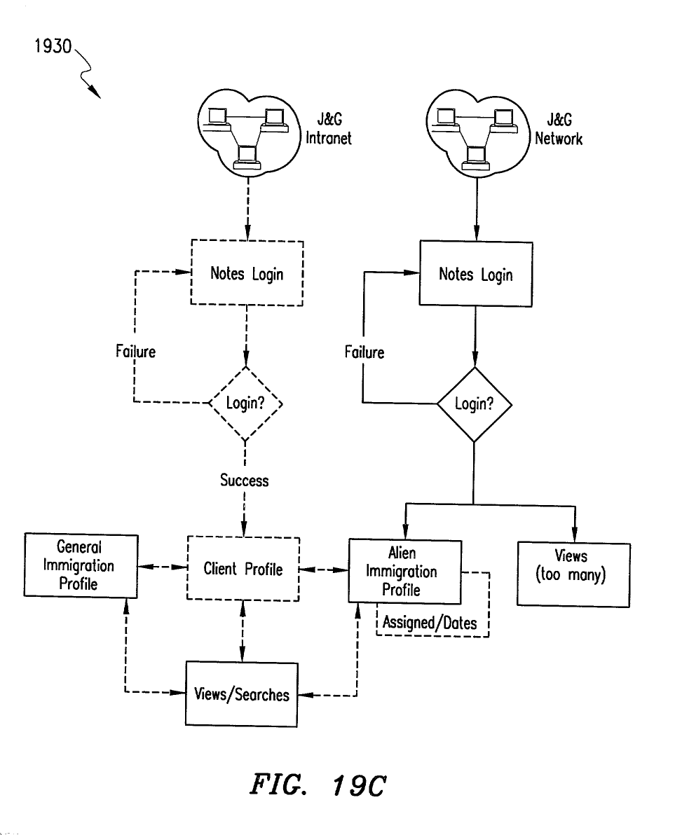

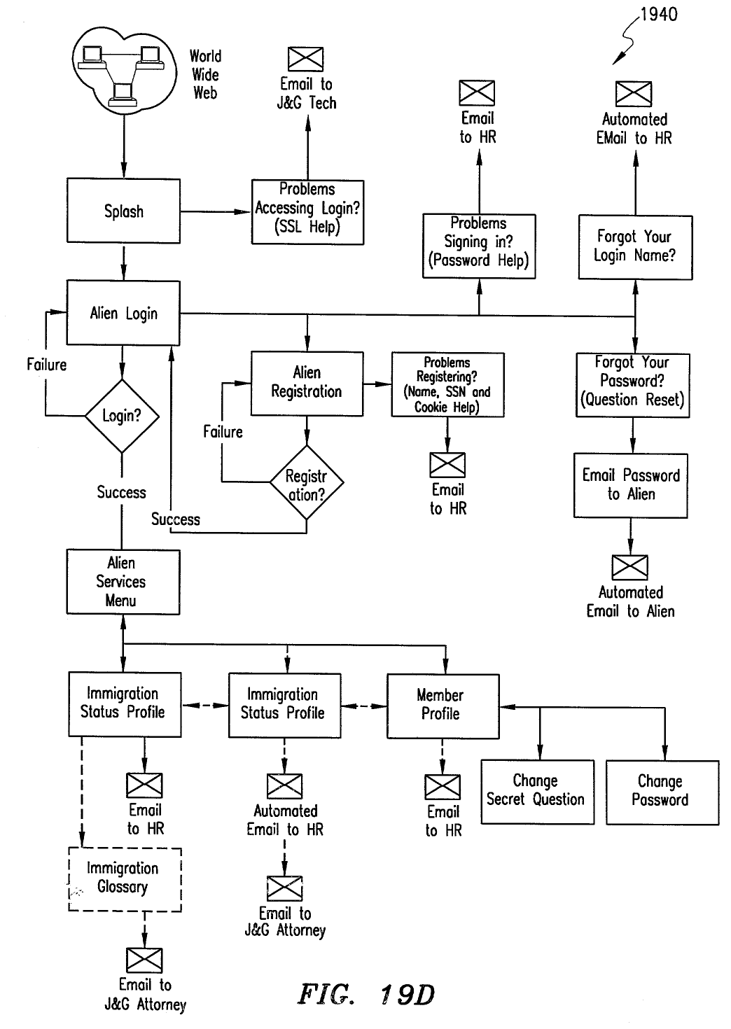

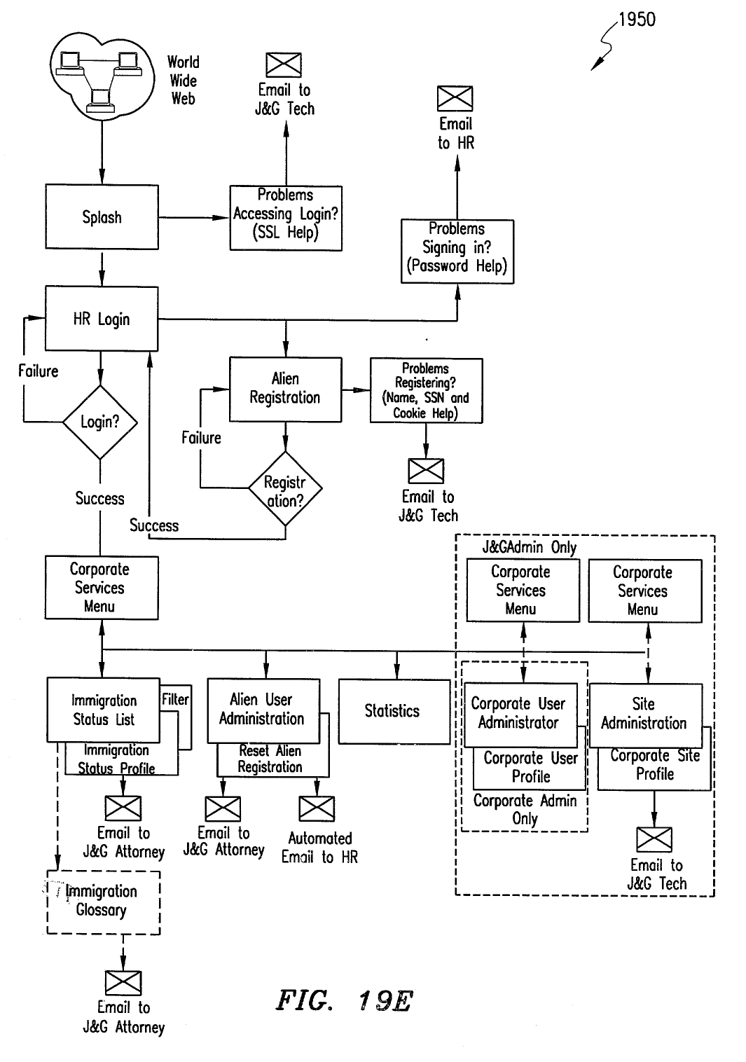

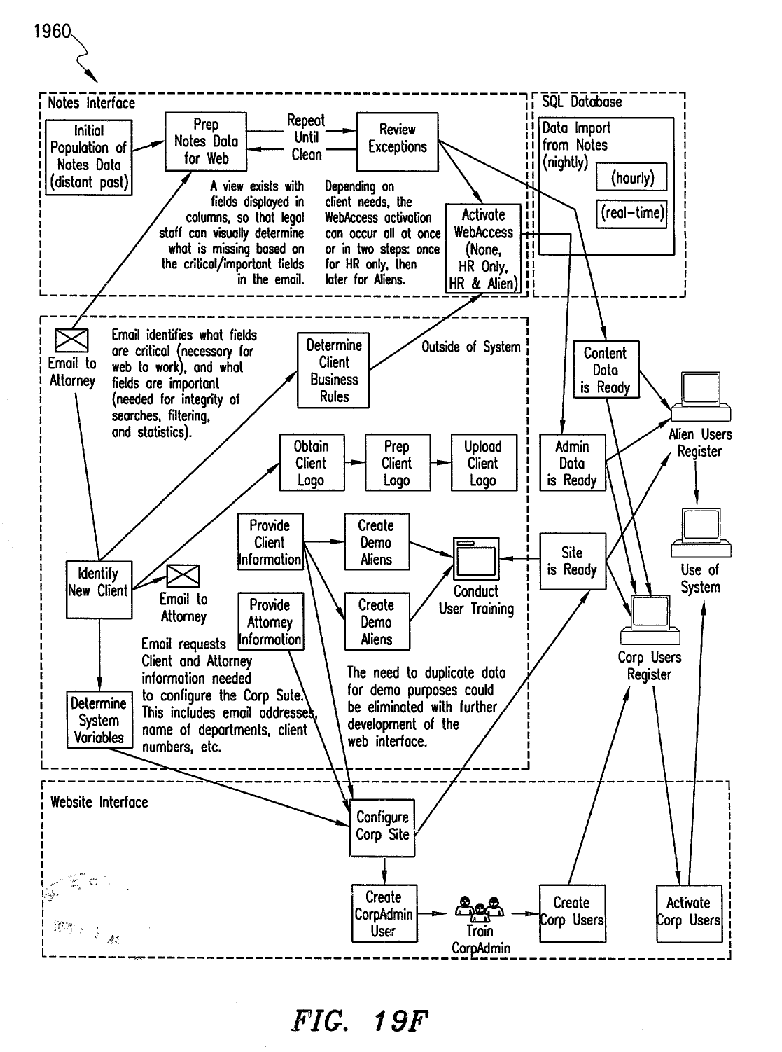

With reference now to FIGS. 19A-19F, exemplary implementations and/or realizations of exemplary embodiment(s) of an immigration status system in accordance with the present invention are illustrated generally at 1910, 1920, 1930, 1940, 1950, and 1960, respectively. It should be understood that each of diagrams 1910, 1920, 1930, 1940, 1950, and 1960 are exemplary only of possible implementation and/or realizations of certain embodiment(s) of the present invention, and they do not limit the present invention as set forth in the claims below. It should be noted that in certain embodiment(s) certain principles of the present invention may be, but are not necessarily, effectuated in phases. Each of the exemplary diagrams 1910, 1920, 1930, 1940, 1950, and 1960 indicate aspects that may be effectuated in a second phase (e.g., Phase II) using dashed lines.

The diagram 1910 illustrates an exemplary system context diagram in which lines indicate network connections and/or data flows. It should be noted that, for example, two databases need not be used in every embodiment. The diagram 1920 illustrates an exemplary Notes/SQL interface in which lines indicate data flows. It should be noted that, for example, an immigration status system may be constructed to execute real-time updates. The diagram 1930 illustrates an exemplary Notes map for a user of a service provider (e.g., a law firm such as Jenkens & Gilchrist, A Professional Corporation). In some embodiment(s), Notes may function as a primary data entry and storage environment for service provider users; in certain other embodiment(s), a browser interface may be used in addition to or instead of Notes.

The diagram 1940 illustrates an exemplary (e.g., WWW) site map for alien users in which self-registration data may be read/write while immigration matter information may be read only. The diagram 1950 illustrates an exemplary (e.g., WWW) site map for client (e.g., HR corporate) users. The exemplary diagram 1950 also illustrates access points for a service provider administrator, where a three-tier rights stratification is in effect (e.g., corporate user, corporate administrator, and then service provider administrator). The diagram 1960 illustrates an exemplary client rollout process in which information is acquired and published to an immigration status system.

Although embodiment(s) of the methods, systems, and arrangements of the present invention have been illustrated in the accompanying Drawings and described in the foregoing Detailed Description, it will be understood that the present invention is not limited to the embodiment(s) disclosed, but is capable of numerous rearrangements, modifications, and substitutions without departing from the spirit and scope of the present invention as set forth and defined by the following claims.

What is claimed is:

1. A method for providing immigration status information by a service provider, comprising the steps of:
receiving immigration-related information from a foreign national;
inputting at least a portion of the immigration-related information into a database at an entry associated with the foreign national;
submitting at least a portion of the immigration-related information to a governmental entity;
receiving an immigration decision from the governmental entity;
modifying the entry associated with the foreign national responsive to the immigration decision;
receiving an inquiry from the foreign national directed to the entry associated with the foreign national over a computer network; and
providing at least a portion of the entry associated with the foreign national over the computer network to the foreign national responsive to the inquiry.

2. The method according to claim 1, wherein said step of receiving immigration-related information from a foreign national comprises the step of receiving biographical information and at least one desired visa type.

3. The method according to claim 1, wherein said step of receiving immigration-related information from a foreign national comprises the step of receiving the immigration-related information at least partially via an employer of the foreign national.

4. The method according to claim 3, wherein the employer comprises a client of the service provider.

5. The method according to claim 1, wherein said step of submitting at least a portion of the immigration-related information to a governmental entity comprises the step of filing an application with at least one of the Immigration and Naturalization Service (INS) and the Department of Labor.

6. The method according to claim 1, wherein said step of receiving an immigration decision from the governmental entity comprises the step of receiving a granted visa type and an associated expiration date.

7. The method according to claim 6, wherein said step of modifying the entry associated with the foreign national responsive to the immigration decision comprises the step of amending the entry to reflect the granted visa type and the associated expiration date.

8. The method according to claim 1, wherein said step of receiving an inquiry from the foreign national directed to the entry associated with the foreign national over a computer network comprises the step of receiving the inquiry from a browser program of the world wide web (WWW).

9. The method according to claim 1, wherein said step of providing at least a portion of the entry associated with the foreign national over the computer network to the foreign national responsive to the inquiry comprises the step of causing a web page to be presented to the foreign national, the web page including immigration status information.

10. A method for providing immigration status information by a service provider, comprising the steps of:
configuring a database to accept multiple entries associated with an employer;
entering a plurality of entries into the database, the plurality of entries associated with the employer, each entry of the plurality of entries corresponding to an employee and including immigration-related information;
submitting at least one immigration application to a governmental entity for each entry of the plurality of entries;
amending a respective entry of the plurality of entries responsive to at least one communication received from the governmental entity that relates to the respective entry;
receiving, via an electronic transmission, a login request from the employer to access the plurality of entries of the database;
logging in the employer responsive to said step of receiving a login request; and
providing to the employer, via a series of electronic transmissions, access to the plurality of entries.

11. The method according to claim 10, wherein said step of configuring a database to accept multiple entries associated with an employer comprises the step of completing a client profile for the employer.

12. The method according to claim 11, wherein said step of completing a client profile for the employer comprises at least one of the steps of selecting whether or not employees of the employer are permitted to access their entries, selecting whether or not employees with only an offer pending are permitted to access their entries, and selecting whether or not an assigned representative of the service provider is presented to the employees.

13. The method according to claim 10, wherein said step of entering a plurality of entries into the database, the plurality of entries associated with the employer, each entry of the plurality of entries corresponding to an employee and including immigration-related information comprises the step of entering at least one immigration visa type that is being applied for and a date of application filing therefor.

14. The method according to claim 10, wherein said step of submitting at least one immigration application to a governmental entity for each entry of the plurality of entries comprises the step of submitting an application for an immigration visa that is related to at least one of H-1 and L-1.

15. The method according to claim 10, wherein said step of submitting at least one immigration application to a governmental entity for each entry of the plurality of entries comprises the step of submitting at least one standard form selected from the group comprising an I-94 form and an I-140 form.

16. The method according to claim 10, wherein said step of amending a respective entry of the plurality of entries responsive to at least one communication received from the governmental entity that relates to the respective entry comprises the step of adding at least one of an application approval date and an immigration visa expiration date.

17. The method according to claim 10, wherein said steps of receiving, via an electronic transmission, a login request from the employer to access the plurality of entries of the database and providing to the employer, via a series of electronic transmissions, access to the plurality of entries are effectuated, at least partly, over the world wide web.

18. The method according to claim 10, wherein said step of providing to the employer, via a series of electronic transmissions, access to the plurality of entries comprises the steps of:
causing at least three options, in link form, to be presented in list form to the employer; and
causing a selected option of the three options to be presented to the employer responsive to an employer selection.

19. The method according to claim 10, wherein said step of providing to the employer, via a series of electronic transmissions, access to the plurality of entries comprises the step of causing a listing of the plurality of entries to be presented to the employer.

20. The method according to claim 19, wherein each item in the listing includes a name of the corresponding employee and at least part of the corresponding immigration-related information.

21. The method according to claim 19, wherein said step of providing to the employer, via a series of electronic transmissions, access to the plurality of entries further comprises the step of providing another listing of another plurality of entries, the another listing differing from the listing by at least one item thereof.

22. The method according to claim 19, wherein said step of providing to the employer, via a series of electronic transmissions, access to the plurality of entries further comprises the step of causing a detailed view of a selected entry to be presented to the employer.

23. The method according to claim 19, wherein said step of providing to the employer, via a series of electronic transmissions, access to the plurality of entries further comprises the step of providing a subset of the plurality of entries to the employer in which the subset is determined based on a filter defined by the employer.

24. The method according to claim 10, wherein said step of providing to the employer, via a series of electronic transmissions, access to the plurality of entries comprises the step of causing site statistics to be presented to the employer, the site statistics collected based on the plurality of entries that are associated with the employer.

25. The method according to claim 10, wherein said step of providing to the employer, via a series of electronic transmissions, access to the plurality of entries comprises the steps of:
enabling the employer to enter a name to conduct a name search from among the plurality of entries;
causing a listing of at least one entry matching the entered name to be presented to the employer; and
causing a detailed view of a selected entry from the listing to be presented to the employer.

26. A method for providing immigration status information, comprising the steps of:
receiving immigration-related information from an alien or an employer thereof;
inputting the immigration-related information into a database at an entry that is associated with the alien and corresponds to the employer;
applying for an immigration visa from a third party for the alien;
adding an immigration expiration date, which is received from the third party responsive to said step of applying for an immigration visa, to the database at the entry;
receiving an inquiry related to the alien from at least one of the alien and the employer; and
providing the immigration expiration date responsive to the inquiry to the at least one of the alien and the employer.

27. The method according to claim 26, further comprising the step of:
sending a notification e-mail to the at least one of the alien and the employer.

28. The method according to claim 27, wherein said step of sending a notification e-mail is executed prior to said step of receiving an inquiry and responsive to said step of adding an immigration expiration date.

29. The method according to claim 26, wherein the employer is comprised of a corporate user from a human resources department of the employer.

30. A system for a service provider to provide immigration status information, comprising
a database, said database including a plurality of entries storing immigration status information, the plurality of entries including:
a first plurality of entries corresponding to a first employer, the first plurality of entries including a first entry associated with a first employee and a second entry associated with a second employee; and
a second plurality of entries corresponding to a second employer, the second plurality of entries including a third entry associated with a third employee and a fourth entry associated with a fourth employee;
a server, said server operatively coupled to said database so as to enable said server to extract entries therefrom and provide them over the world wide web; and
wherein at least one of said server and said database are configured so as to enable the service provider to provide, upon request, at least one of the following:
the first entry and the second entry to the first employer;
the first entry to the first employee;
the second entry to the second employee;
the third entry and the fourth entry to the second employer;
the third entry to the third employee; and
the fourth entry to the fourth employee.

31. The system according to claim 30, wherein the request includes an identification and authentication component.

32. The system according to claim 30, wherein the first entry stores immigration status information pertaining to the first employee, the second entry stores immigration status information pertaining to the second employee, the third entry stores immigration status information pertaining to the third employee, and the fourth entry stores immigration status information pertaining to the fourth employee.

33. The system according to claim 32, wherein the first employee is provided access only to the first entry, the second employee is provided access only to the second entry, the third employee is provided access only to the third entry, and the fourth employee is provided access only to the fourth entry.

34. The system according to claim 33, wherein access is restricted using an identification and authentication approach.

35. The system according to claim 30, wherein the first employer is restricted from accessing the third entry and the fourth entry, and the second employer is restricted from accessing the first entry and the second entry.
